(19) United States
(12) Patent Application Publication
(10) Pub. No.: US 2026/0141308 A1
(43) Pub. Date: May 21, 2026

(54) OPERATIONS RELATED TO AI/ML MODEL

(71) Applicant: Huawei Technologies Co., Ltd., Shenzhen (CN)

(72) Inventors: Hao Tang, Ottawa (CA); Jianglei Ma, Ottawa (CA); Wen Tong, Ottawa (CA); Yiqun Ge, Ottawa (CA)

(21) Appl. No.: 19/411,136

(22) Filed: Dec. 5, 2025

Related U.S. Application Data
(63) Continuation of application No. PCT/CN2023/115645, filed on Aug. 30, 2023.
(60) Provisional application No. 63/506,869, filed on Jun. 8, 2023.

(51) Int. Cl. G06N 20/00

(52) U.S. Cl. CPC G06N 20/00

(57) ABSTRACT

Example embodiments of the present disclosure relate to operations associated with an artificial intelligence/machine learning (AI/ML) model. In an aspect, a first device transmits, to a second device, a request indicating the second device to provide an AI/ML model. The request comprises a request identifier (ID), information of a task, a first parameter of input data of the AI/ML model, or a second parameter of output data of the AI/ML model. The first device then receives a response from the second device.

### CROSS-REFERENCE TO RELATED APPLICATIONS

This application is a continuation of International Application No. PCT/CN2023/115645, filed on Aug. 30, 2023, which claims priority to U.S. Provisional Application No. 63/506,869, filed on Jun. 8, 2023, both of which are hereby incorporated by reference in their entireties.

### TECHNICAL FIELD

Example embodiments of the present disclosure generally relate to the field of communications, and in particular, to operations associated with an artificial intelligence/machine learning (AI/ML) model.

### BACKGROUND

Artificial intelligence (AI), and in particular deep machine learning (ML), is a wide-ranging branch of computer science concerned with building smart machines capable of performing tasks that typically require human intelligence. It is expected that the introduction of AI will create a paradigm shift in virtually every sector of the tech industry and AI is expected to play a role in advancement of network technologies. For example, existing communication techniques, which rely on classical analytical modeling of channels, have enabled wireless communications to take place at close to the theoretical Shannon limit. To further maximize efficient use of the signal space, existing techniques may be unsatisfactory. AI is expected to help address this challenge. Other aspects of wireless communication may benefit from the use of AI, particularly in future generations of wireless technologies, such as technologies in advanced 5G and future 6G systems, and beyond.

To support the use of AI in a wireless network, an appropriate network architecture is needed. Accordingly, it would be useful to provide a network architecture that supports the use of AI in wireless communications, including for current and future generations of wireless systems. More and more AI tasks will be in the future network, if for each AI task, radio access network (RAN) node (e.g. BS) trains its own model, the fragmented models are too expensive and not efficient.

### SUMMARY

In general, example embodiments of the present disclosure provide a solution for operations associated with an artificial intelligence/machine learning (AI/ML) model, especially for customized local AI/ML model at a random access network (RAN) node from a global foundation model at a core network (CN) node or a third (3^{rd}) party (for example, a multi-access edge computing (MEC) platform).

In a first aspect, there is provided a method. The method comprises: transmitting, at a first device and to a second device, a request indicating the second device to provide an artificial intelligence/machine learning (AI/ML) model, wherein the request comprises at least one of the following: a request identifier (ID), information of a task, a first parameter of input data of the AI/ML model, or a second parameter of output data of the AI/ML model; and receiving a response from the second device. In this way, a relatively light-weighted customized local AI/ML model meeting requirements specified by the first device can be obtained from a rather big (and “heavy”) global foundation model at the second device, reducing the training complexity at the first device.

In some example embodiments, the response may comprise the request ID and one of an acknowledgement (ACK) or a negative acknowledgement (NACK). In this way, the first device can know whether the requested AI/ML model is available or not.

In some example embodiments, the information may comprise a task index indicative of a row of a task table. In addition or as an alternative, the information may comprise a key performance indicator (KPI) index indicative of a KPI requirement for the task, the KPI index indicating a row of a KPI table. In addition or as an alternative, the information may comprise a scenario index indicative of a scenario in which the task is to be performed, the scenario index indicating a row of a scenario table. In this way, the first device can specify some requirements for the desired AI/ML model in the request, in an explicit manner, so as to an AI/ML model which meets the requirements specified by the first device can be obtained from the second device.

In some example embodiments, the task index may indicate a group of functions of an AI/ML model and an achievable performance of the AI/ML model. In this way, the first device can specify some requirements for the desired AI/ML model in the request, in an implicit manner with the task index, so as to an AI/ML model which meets the requirements specified by the first device can be obtained from the second device.

In some example embodiments, the task index may indicate at least one radio resource control (RRC) parameter related to an AI/ML model and a function of the AI/ML model. In this way, the first device can specify some requirements for the desired AI/ML model in the request, so as to an AI/ML model which meets the requirements specified by the first device can be obtained from the second device.

In some example embodiments, the KPI requirement may comprise a performance requirement. In addition or as an alternative, the KPI requirement may comprise an overhead requirement. In addition or as an alternative, the KPI requirement may comprise an inference complexity requirement for an AI/ML model. In addition or as an alternative, the KPI requirement may comprise a training complexity requirement for the AI/ML model. In this way, the first device can specify some KPI requirement for the desired AI/ML model in the request, so as to an AI/ML model which meets the KPI requirement can be obtained from the second device.

In some example embodiments, the scenario may comprise an urban outdoor scenario. In addition or as an alternative, the scenario may comprise an urban indoor scenario. In addition or as an alternative, the scenario may comprise a rural scenario. In addition or as an alternative, the scenario may comprise a highway scenario. In addition or as an alternative, the scenario may comprise a line-of-sight (LOS) scenario. In addition or as an alternative, the scenario may comprise a non-line-of-sight (NLOS) scenario. In addition or as an alternative, the scenario may comprise a windy scenario. In addition or as an alternative, the scenario may comprise a rainy scenario. In this way, the first device can specify a desired scenario (via a scenario index) for the desired AI/ML model in the request, so as to an AI/ML model which is suitable for the scenario can be obtained from the second device.

In some example embodiments, the first parameter may comprise a data type. In addition or as an alternative, the first parameter may comprise a data dimension. In addition or as an alternative, the first parameter may comprise a data granularity. The same is true for the second parameter. In other words, the second parameter may comprise a data type. In addition or as an alternative, the second parameter may comprise a data dimension. In addition or as an alternative, the second parameter may comprise a data granularity. In this way, the first device can specify a desired data type and/or data dimension and/or data granularity for the desired AI/ML model in the request, so as to an AI/ML model which meets the desired data type and/or data dimension and/or data granularity can be obtained from the second device.

In some example embodiments, the request ID may be one of a plurality of request IDs, and the plurality of request IDs may indicate a plurality of requests transmitted from the first device to the second device for requesting a plurality of respective AI/ML models. In this way, the first device can request a plurality of respective AI/ML models via a single request, reducing communication overhead as compared with a case where the request for each of the plurality of AI/ML models are transmitted separately.

In some example embodiments, the response may comprise the ACK, and the response may further indicate a common AI/ML model, where in the response the common AI/MI model is associated with the plurality of request IDs. Alternatively, the response may further indicate the plurality of respective AI/ML models among which an AI/ML model has a first model part and a second model part, the first model part is common to the plurality of respective AI/ML models, and the second model part is different from other AI/ML models among the plurality of respective AI/ML models. In this way, multiple AI/ML models can be feedback from the second device to the first device in a single response, reducing communication overhead as compared with a case where each of the multiple AI/ML models is transmitted separately.

In some example embodiments, the response may indicate an AI/ML model, wherein in the response the AI/ML model is associated with the ACK and at least one request IDs of the plurality of request IDs. In addition or as an alternative, the response may indicate the NACK indicating no AI/ML model is available at the second device for at least one request IDs of the plurality of request IDs. In this way, the response can indicate a case where for multiple request IDs in the request, in the response an AI/ML model is feedback with respect to a first request ID among the multiple request IDs, while a NACK is feedback with respect to a second request ID among the multiple request IDs. In other words, the second device can respond to the request from the first device as per request ID in the request, and provide AI/ML model(s) requested by the first device to the most extent of the capability of the second device.

In some example embodiments, the response may comprise the ACK, and the response may further comprise a model ID of the AI/ML model. In addition or as an alternative, the response may further comprise a model structure of the AI/ML model. In addition or as an alternative, the response may further comprise at least one model parameter of the AI/ML model. In addition or as an alternative, the response may further comprise an indication of whether the AI/ML model is a differential model or a whole model. In this way, provision of the AI/ML model(s) from the second device to the first device can be more flexible and in more granularities.

In some example embodiments, the indication may be indicative of a differential model, and the response may further comprise a model ID of a reference model, information indicative of one or more model parameters of the AI/ML model which are different from the reference AI/ML model, and one or more values of the one or more model parameters of the AI/ML model. In this way, for an AI/ML model having a common part and a different part from a reference AI/ML model, the second device does not need to transmit the whole AI/ML model to the first device; instead, a model ID of the reference AI/ML model, information indicative of one or more parameters of the AI/ML model and one or more values of the one or more model parameters will suffice for the second device to indicate the AI/ML model to the first device. Therefore, communication overhead can be reduced as compared with a case where the AI/ML model itself is transmitted from the second device to the first device.

In some example embodiments, the method may further comprises: performing fine-tuning on the AI/ML model to obtain a fine-tuned AI/ML model; providing input data to the fine-tuned AI/ML model to obtain a first output; obtaining a second output of a pre-trained AI/ML model to which the input data is provided, wherein the AI/ML model is generated from the pre-trained AI/ML model which is stored at the second device; and monitoring inference performance of the fine-tuned AI/ML model based on the first output and the second output. In this way, inference performance (in other words, accuracy) of the local AI/ML model at the first device can be monitored.

In some example embodiments, monitoring the inference performance comprises: determining a difference between the first output and the second output. In this way, inference performance (in other words, accuracy) of the local AI/ML model at the first device can be monitored in the form of the difference between the first output and the second output.

In some example embodiments, the method may further comprises: based on determining that the difference is greater than a threshold, performing a responsive operation, wherein the responsive operation comprises at least one of the following: performing further fine-tuning on the fine-tuned AI/ML model, switching to another AI/ML model at the first device, or performing the task without using an AI/ML model. In this way, if the difference is greater than a threshold (i.e., the accuracy of the local AI/ML model at the first device deteriorates to be greater than the threshold), the first device can either no longer use the current AI/ML model any more, or perform further fine-tuning on the AI/ML model first to improve the accuracy of the AI/ML model to be accurate enough before continuing to perform the task.

In some example embodiments, obtaining the second output comprises: transmitting the input data to the second device; and receiving the second output from the second device. In this way, output from the pre-trained big model (which is used as a standard AI/ML model) can be obtained to be compared with a local output at the first device to determine whether inference performance of the local AI/ML model at the first device is good enough.

In some example embodiments, the method further comprises: based on determining that the difference is greater than the threshold, transmitting, to the second device, local data at the first device. In this way, the first device can rely on the second device to, with help of the data received from the first device, provide another AI/ML model which is more suitable for the first device to perform local tasks.

In some example embodiments, the first device may be a terminal device and the second device may be one of an access network device, a core network device, or a third party device. As an alternative, the first device may be an access network device and the second device may be one of a core network device or a third party device. In this way, AI/ML model transfer becomes more flexible and convenient between the first and second devices.

In this way, according to the first aspect and its example embodiments, a relatively light-weighted customized local AI/ML model can be obtained from a rather big (and “heavy”) global foundation model at the second device, reducing the training complexity at the first device. Meanwhile, the local AI/ML model at the first device is more accurate, thus the first device can perform tasks more accurately.

In a second aspect, there is provided a method. The method comprises: receiving, at a second device and from a first device, a request indicating the second device to provide an artificial intelligence/machine learning (AI/ML) model, wherein the request comprises at least one of the following: a request identifier (ID), task information of the task, a first parameter of input data of the AI/ML model, or a second parameter of output data of the AI/ML model; and transmitting a response to the first device. In this way, the second device does not need to transmit a rather big (and “heavy”) global foundation model to the first device; instead, the second device can transmit a relatively light-weighted customized AI/ML model to the first device. Therefore, the training complexity at the first device can be greatly reduced. Meanwhile, the AI/ML model at the first device is more accurate and “tuned” for the first device, enabling the first device to perform tasks more accurately.

In some example embodiments, the response comprises the request ID and one of an acknowledgement (ACK) or negative acknowledgement (NACK). In this way, the first device can know whether the requested AI/ML model is available or not.

In some example embodiments, the task information comprises at least one of the following: a task index indicative of a row of a task table, a key performance indicator (KPI) index indicative of a KPI requirement for the task, the KPI index indicating a row of a KPI table, or a scenario index indicative of a scenario in which the task is to be performed, the scenario index indicating a line of a scenario table. In this way, the first device can specify some requirements for the desired AI/ML model in the request, in an explicit manner, so as to an AI/ML model which meets the requirements specified by the first device can be obtained from the second device.

In some example embodiments, the task index indicates a group of functions of an AI/ML model and an achievable performance of the AI/ML model. In this way, the first device can specify some requirements for the desired AI/ML model in the request, in an implicit manner with the task index, so as to an AI/ML model which meets the requirements specified by the first device can be obtained from the second device.

In some example embodiments, the task index indicates at least one radio resource control (RRC) parameter related to an AI/ML model and a function of the AI/ML model. In this way, the first device can specify some requirements for the desired AI/ML model in the request, so as to an AI/ML model which meets the requirements specified by the first device can be obtained from the second device.

In some example embodiments, the KPI requirement may comprise a performance requirement. In addition or as an alternative, the KPI requirement may comprise an overhead requirement. In addition or as an alternative, the KPI requirement may comprise an inference complexity requirement for an AI/ML model. In addition or as an alternative, the KPI requirement may comprise a training complexity requirement for the AI/ML model. In this way, the first device can specify some KPI requirement for the desired AI/ML model in the request, so as to an AI/ML model which meets the KPI requirement can be obtained from the second device.

In some example embodiments, the scenario may comprise an urban outdoor scenario. In addition or as an alternative, the scenario may comprise an urban indoor scenario. In addition or as an alternative, the scenario may comprise a rural scenario. In addition or as an alternative, the scenario may comprise a highway scenario. In addition or as an alternative, the scenario may comprise a line-of-sight (LOS) scenario. In addition or as an alternative, the scenario may comprise a non-line-of-sight (NLOS) scenario. In addition or as an alternative, the scenario may comprise a windy scenario. In addition or as an alternative, the scenario may comprise a rainy scenario. In this way, the first device can specify a desired scenario (via a scenario index) for the desired AI/ML model in the request, so as to an AI/ML model which is suitable for the scenario can be obtained from the second device.

In some example embodiments, the first parameter may comprise a data type. In addition or as an alternative, the first parameter may comprise a data dimension. In addition or as an alternative, the first parameter may comprise a data granularity. The same is true for the second parameter. In other words, the second parameter may comprise a data type. In addition or as an alternative, the second parameter may comprise a data dimension. In addition or as an alternative, the second parameter may comprise a data granularity. In this way, the first device can specify a desired data type and/or data dimension and/or data granularity for the desired AI/ML model in the request, so as to an AI/ML model which meets the desired data type and/or data dimension and/or data granularity can be obtained from the second device.

In some example embodiments, the request ID may be one of a plurality of request IDs, and the plurality of request IDs may indicate a plurality of requests transmitted from the first device to the second device for requesting a plurality of respective AI/ML models. In this way, the first device can request a plurality of respective AI/ML models via a single request, reducing communication overhead as compared with a case where the request for each of the plurality of AI/ML models are transmitted separately.

In some example embodiments, the response may comprise the ACK, and the response may further indicate a common AI/ML model, where in the response the common AI/MI model is associated with the plurality of request IDs. Alternatively, the response may further indicate the plurality of respective AI/ML models among which an AI/ML model has a first model part and a second model part, the first model part is common to the plurality of respective AI/ML models, and the second model part is different from other AI/ML models among the plurality of respective AI/ML models. In this way, multiple AI/ML models can be feedback from the second device to the first device in a single response, reducing communication overhead as compared with a case where each of the multiple AI/ML models is transmitted separately.

In some example embodiments, the response may indicate an AI/ML model, wherein in the response the AI/ML model is associated with the ACK and at least one request IDs of the plurality of request IDs. In addition or as an alternative, the response may indicate the NACK indicating no AI/ML model is available at the second device for at least one request IDs of the plurality of request IDs. In this way, the response can indicate a case where for multiple request IDs in the request, in the response an AI/ML model is feedback with respect to a first request ID among the multiple request IDs, while a NACK is feedback with respect to a second request ID among the multiple request IDs. In other words, the second device can respond to the request from the first device as per request ID in the request, and provide AI/ML model(s) requested by the first device to the most extent of the capability of the second device.

In some example embodiments, the response may comprise the ACK, and the response may further comprise a model ID of the AI/ML model. In addition or as an alternative, the response may further comprise a model structure of the AI/ML model. In addition or as an alternative, the response may further comprise at least one model parameter of the AI/ML model. In addition or as an alternative, the response may further comprise an indication of whether the AI/ML model is a differential model or a whole model. In this way, provision of the AI/ML model(s) from the second device to the first device can be more flexible and in more granularities.

In some example embodiments, the indication may be indicative of a differential model, and the response may further comprise a model ID of a reference model, information indicative of one or more model parameters of the AI/ML model which are different from the reference AI/ML model, and one or more values of the one or more model parameters of the AI/ML model. In this way, for an AI/ML model having a common part and a different part from a reference AI/ML model, the second device does not need to transmit the whole AI/ML model to the first device; instead, a model ID of the reference AI/ML model, information indicative of one or more parameters of the AI/ML model and one or more values of the one or more model parameters will suffice for the second device to indicate the AI/ML model to the first device. Therefore, communication overhead can be reduced as compared with a case where the AI/ML model itself is transmitted from the second device to the first device.

In some example embodiments, the method further comprises: receiving, from the first device, an input data (for example, in a format of embedding data); and providing the input data to a local AI/ML model to obtain a second output, wherein the AI/ML model being generated based on the local AI/ML model; transmitting the second output to the first device. In this way, with the second output from the second device, the inference performance (in other words, accuracy) of the local AI/ML model at the first device can be monitored.

In some example embodiments, the first device may be a terminal device and the second device may be one of an access network device, a core network device, or a third party device. As an alternative, the first device may be an access network device and the second device may be one of a core network device or a third party device. In this way, AI/ML model transfer becomes more flexible and convenient between the first and second devices.

In this way, according to the second aspect and its example embodiments, rather than a rather big (and “heavy”) global foundation model, a relatively light-weighted customized AI/ML model can be provided to the first device, reducing the training complexity at the first device. Meanwhile, the AI/ML model at the first device is more accurate, thus the first device can perform tasks more accurately. Further, the second device may use data received from the first device to train the global foundation model to be more accurate for the plurality of tasks.

In a third aspect, there is provided a first device. The first device comprises: a transceiver; and a processor communicatively coupled with the transceiver, wherein the processor is configured to: transmit, at a first device and to a second device, a request indicating the second device to provide an artificial intelligence/machine learning (AI/ML) model, wherein the request comprises at least one of the following: a request identifier (ID), task information of the task, a first parameter of input data of the AI/ML model, or a second parameter of output data of the AI/ML model; and receive a response from the second device. In this way, a relatively light-weighted customized local AI/ML model meeting requirements specified by the first device can be obtained from a rather big (and “heavy”) global foundation model at the second device, reducing the training complexity at the first device. Meanwhile, the local AI/ML model at the first device is more accurate, thus the first device can perform tasks more accurately.

In a fourth aspect, there is provided a second device. The second device comprises: a transceiver; and a processor communicatively coupled with the transceiver, wherein the processor is configured to: receive, at a second device and from a first device, a request indicating the second device to provide an artificial intelligence/machine learning (AI/ML) model, wherein the request comprises at least one of the following: a request identifier (ID), task information of the task, a first parameter of input data of the AI/ML model, or a second parameter of output data of the AI/ML model; and transmit a response to the first device. In this way, the second device does not need to transmit rather big (and “heavy”) global foundation model to the first device; instead, the second device can transmit a relatively light-weighted customized AI/ML model to the first device. Therefore, the training complexity at the first device can be greatly reduced. Meanwhile, the AI/ML model at the first device is more accurate and “tuned” for the first device, enabling the first device to perform tasks more accurately.

In a fifth aspect, there is provided a non-transitory computer-readable storage medium comprising computer program stored thereon. The computer program, when executed on at least one processor, cause the at least one processor to perform the method of any of the first or second aspect. In this way, the second device does not need to transmit rather big (and “heavy”) global foundation model to the first device; instead, the second device can transmit a relatively light-weighted customized AI/ML model to the first device. Therefore, the training complexity at the first device can be greatly reduced. Meanwhile, the AI/ML model at the first device is more accurate and “tuned” for the first device, enabling the first device to perform tasks more accurately.

In a sixth aspect, there is provided a chip comprising at least one processing circuit configured to perform the method of any the first or second aspect. In this way, the second device does not need to transmit rather big (and “heavy”) global foundation model to the first device; instead, the second device can transmit a relatively light-weighted customized AI/ML model to the first device. Therefore, the training complexity at the first device can be greatly reduced. Meanwhile, the AI/ML model at the first device is more accurate and “tuned” for the first device, enabling the first device to perform tasks more accurately.

In a seventh aspect, there is provided a computer program product tangibly stored on a computer-readable medium and comprising computer-executable instructions which, when executed, cause an apparatus to perform a method of any of the first or second aspect. In this way, the second device does not need to transmit rather big (and “heavy”) global foundation model to the first device; instead, the second device can transmit a relatively light-weighted customized AI/ML model to the first device. Therefore, the training complexity at the first device can be greatly reduced. Meanwhile, the AI/ML model at the first device is more accurate and “tuned” for the first device, enabling the first device to perform tasks more accurately.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of a network environment in which some example embodiments of the present disclosure may be implemented;

FIG. 1B illustrates an example communication system 100B in which some example embodiments of the present disclosure may be implemented;

FIG. 1C illustrates an example of an electric device and a base station in accordance with some example embodiments of the present disclosure;

FIG. 1D illustrates units or modules in a device in accordance with some example embodiments of the present disclosure;

FIG. 1E illustrates a wireless system implementing an example network architecture, in accordance with some example embodiments of the present disclosure;

FIG. 1F illustrates another example wireless system in accordance with some example embodiments of the present disclosure;

FIG. 1G illustrates a further example wireless system in accordance with some example embodiments of the present disclosure;

FIG. 1H illustrates an example apparatus that may implement the methods and teachings in accordance with some example embodiments of the present disclosure;

FIG. 1I illustrates a schematic diagram of an example pre-trained big model in accordance with some example embodiments of the present disclosure;

FIG. 1J illustrates a simplified block diagram of an example dataflow in an example operation of AI modules in accordance with some example embodiments of the present disclosure;

FIG. 2 illustrates a signaling chart illustrating an example communication process in accordance with some example embodiments of the present disclosure;

FIG. 3 illustrates a schematic diagram of an example AI model implementation in accordance with some embodiments of the present disclosure;

FIG. 4 illustrates a signaling chart illustrating another example communication process in accordance with some embodiments of the present disclosure;

FIG. 5A illustrates a whole AI/ML model in accordance with some embodiments of the present disclosure;

FIG. 5B illustrates a differential AI/ML model in accordance with some embodiments of the present disclosure;

FIG. 6 illustrates a flowchart of an example method implemented at a first device in accordance with some embodiments of the present disclosure;

FIG. 7 illustrates another flowchart of an example method implemented at a second device in accordance with some embodiments of the present disclosure;

FIG. 8 illustrates a simplified block diagram of an apparatus according to some example embodiments of the present disclosure;

FIG. 9 illustrates a simplified block diagram of another apparatus according to some example embodiments of the present disclosure; and

FIG. 10 illustrates a simplified block diagram of a device that is suitable for implementing some example embodiments of the present disclosure.

Throughout the drawings, the same or similar reference numerals represent the same or similar elements.

### DETAILED DESCRIPTION OF ILLUSTRATIVE EMBODIMENTS

Principles of the present disclosure will now be described with reference to some example embodiments. It is to be understood that these embodiments are described for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), Wireless Fidelity (WiFi) and so on. Furthermore, the communications between a terminal device and a network device in the communication network may be performed according to any suitable generation communication protocols, including, but not limited to, the fourth generation (4G), 4.5G, the future fifth generation (5G), IEEE 802.11 communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a WiFi device, a relay, a low power node such as a femto, a pico, and so forth, depending on the applied terminology and technology. In the following description, the terms “network device”, “AP device”, “AP” and “access point” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), a station (STA) or station device, or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a VR (virtual reality) device, an XR (extended reality) device, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “station”, “station device”, “STA”, “terminal device”, “communication device”, “terminal”, “user equipment” and “UE” may be used interchangeably.

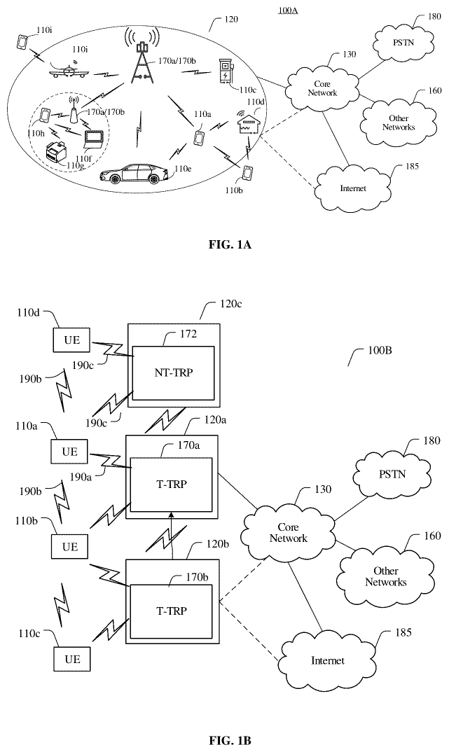

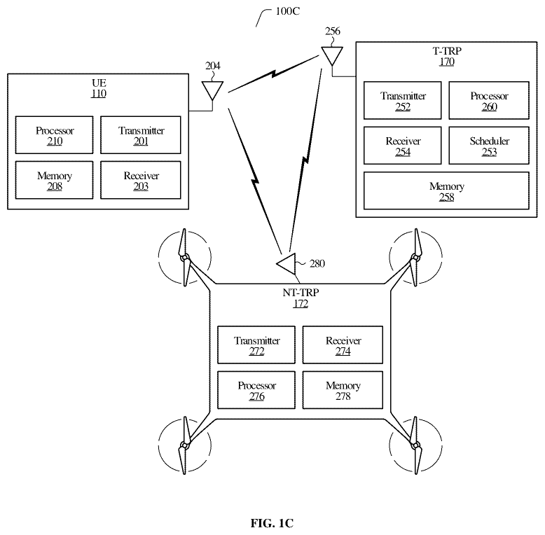

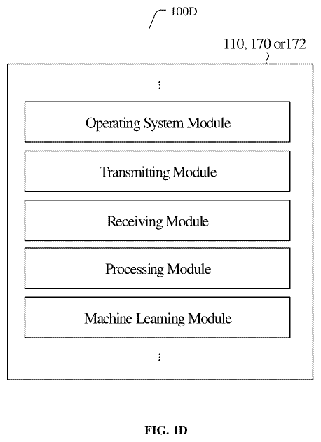

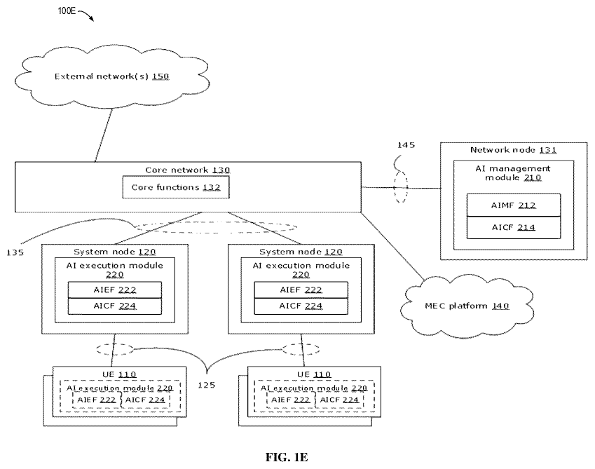

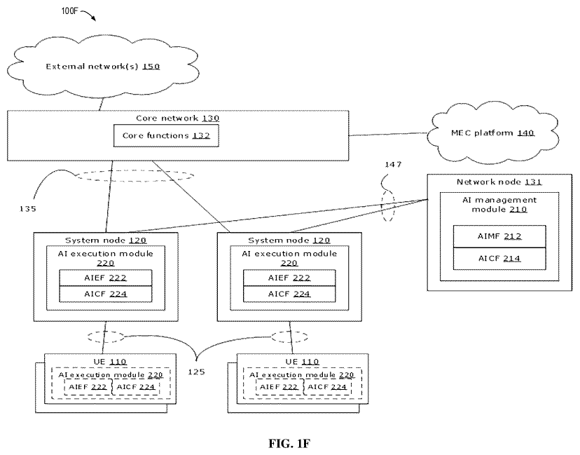

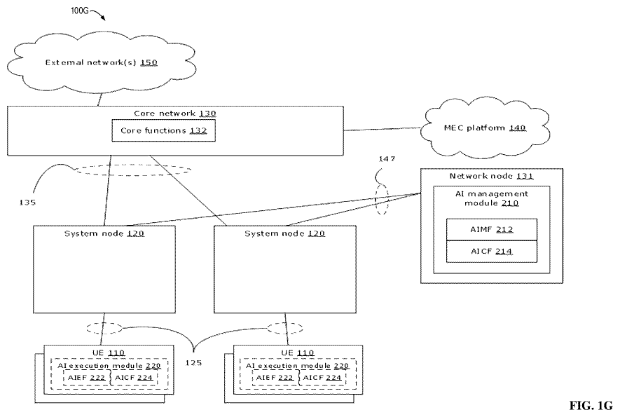

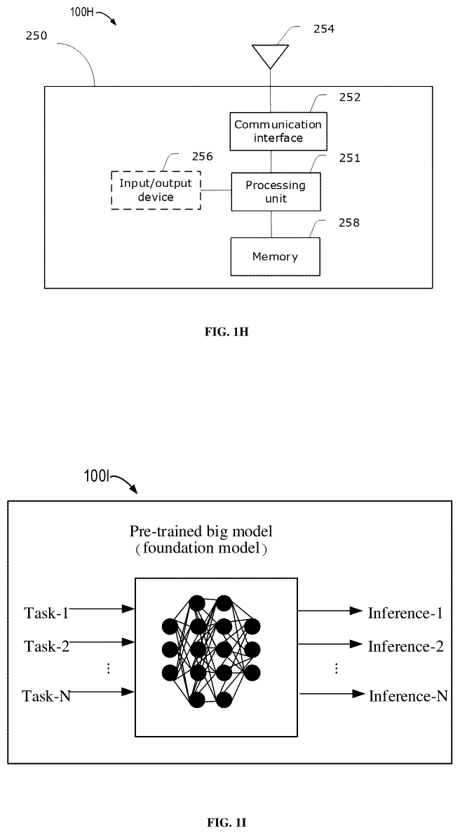

Referring to FIG. 1A, as an illustrative example without limitation, a simplified schematic illustration of a communication system is provided. The communication system 100A comprises a radio access network 120. The radio access network 120 may be a next generation (e.g. sixth generation (6G) or later) radio access network, or a legacy (e.g. 5G, 4G, 3G or 2G) radio access network. One or more communication user equipment (UE, also referred to as electric device (ED)) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 180, the internet 150, and other networks 160. The other networks 160 may include a multi-access edge computing (MEC) platform, which will be described later in more detail.

FIG. 1B illustrates an example communication system 100B. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 180, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172. As described above, the other networks 160 may include a multi-access edge computing (MEC) platform.

Any ED 110 may be alternatively or additionally configured to interface, access, or communicate with any other T-TRP 170a-170b and NT-TRP 172, the internet 150, the core network 130, the PSTN 180, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 180, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 185. PSTN 140 may include circuit switched telephone networks for providing plain old telephone service (POTS). Internet 185 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

FIG. 1C illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 185 in FIG. 1A). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 1D. FIG. 1D illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

FIG. 1E illustrates a wireless system 100E implementing an example network architecture, in accordance with embodiments of the present disclosure. The wireless system 100E enables multiple wireless or wired elements to communicate data and other content. The wireless system 100E may enable content (e.g., voice, data, video, text, etc.) to be communicated (e.g., via broadcast, narrowcast, peer-to-peer, etc.) among entities of the system 100E. The wireless system 100E may operate by sharing resources such as bandwidth. The wireless system 100E may be suitable for wireless communications using 5G technology and/or later generation wireless technology (e.g., 6G or later generations). In some examples, the wireless system 100E may also accommodate some legacy wireless technology (e.g., 3G or 4G wireless technology).

In the example shown, the wireless system 100E includes a plurality of user equipment (UEs) 110, a plurality of system nodes 120, and a core network 130. The core network 130 may be connected to a multi-access edge computing (MEC) platform 140, and one or more external networks 150 (e.g., a public switched telephone network (PSTN), the internet, other private network, etc.). Although certain numbers of these components or elements are shown in FIG. 1E, any reasonable number of these components or elements may be included in the wireless system 100E.

Each UE 110 may independently be any suitable end device for wireless operation and may include such electronic devices (or may be referred to) as a wireless transmit/receive unit (WTRU), customer premises equipment (CPE), a smart device, an Internet of Things (IoT) device, a wireless-enabled vehicle, a mobile station, a fixed or mobile subscriber unit, a cellular telephone, a station (STA), a machine type communication (MTC) device, a personal digital assistant (PDA), a smartphone, a laptop, a computer, a tablet, a wireless/wireline sensor, or a consumer electronics device, among other possibilities. Future generation UEs 110 may be referred to using other terms. For example, UEs 110 may be referred to generally as electronic devices (EDs).

A system node 120 may be any node of an access network (AN) (also referred to as a radio access network (RAN)). For example, a system node 120 may be a base station (BS) of an AN. Each system node 120 is configured to wirelessly interface with one or more of the UEs 110 to enable access to the respective AN. A given UE 110 may connect with a given system node 120 to enable access to the core network 130, another system node 120, the MEC platform 140 and/or external network(s) 150. For example, the system node 120 may include (or be) one or more of several well-known devices, such as a base transceiver station (BTS), a radio base station, a Node-B (NodeB), an evolved NodeB (eNodeB), a Home eNodeB, a gNodeB (sometimes called a next-generation Node B), a transmission point (TP), a transmit and receive point (TRP), a site controller, an access point (AP), an AP with sensing functionality, a dedicated sensing node, or a wireless router, among other possibilities. A system node 120 may also be or include a mobile node, such as a drone, an unmanned aerial vehicle (UAV), a network-enabled vehicle (e.g., autonomous or semi-autonomous vehicle), etc. A system node 120 may also be or include a non-terrestrial node, such as a satellite. Future generation system nodes 120 may encompass other network-enabled nodes, and may be referred to using other terms.

The core network 130 may include one or more core servers or server clusters. The core network 130 provides core functions 132, such as core access and mobility management function (AMF), user plane function (UPF), and sensing management/control function, among others. UEs 110 may be provided with access to the core functions 132 via respective system nodes 120. The core network 130 may also serve as a gateway access between (i) the system nodes 120 or UEs 110 or both, and (ii) the external network(s) 150 and/or MEC platform 140. The core network 130 may provide a convergence interface (not shown) that is a common interface for all access types (e.g., wireless or wired access types).

The MEC platform 140 may be a distributed computing platform, in which a plurality of MEC hosts (typically edge servers) provide distributed computing resources (e.g., memory and processor resources). The MEC platform 140 may provide functions and services closer to end users (e.g., physically located closer to the system nodes 120, compared to the core network 130), which may help to reduce latency in provisioning of such functions and services.

FIG. 1E also illustrates a network node 131, which may be any node in the network-side of the wireless system 100A (i.e., any node that is not a UE 110). For example, the network node 131 may be a node of the MEC platform 140 (e.g., a MEC host), may be a node of an external network 150 (e.g., a network server), or a node within the core network 130 (e.g., a core server), among other possibilities. The network node 131 may be outside of the core network 130 but directly connected to the core network 130. The network node 131 may be a node that is connected between the core network 130 and the system nodes 120 (e.g., outside of but close to the ANs, or within one or more ANs). The network node 131 may be dedicated to supporting AI capabilities (e.g., dedicated to performing AI management functions as disclosed herein), and may be accessible by multiple entities of the wireless system 100A (including the external networks 150 and MEC platform 140, although such links are not shown in FIG. 1A for simplicity), for example. It should be noted that, although the present disclosure provides examples in which the network node 131 provides certain AI functionalities (e.g., an AI management module 210, discussed further below), the functionality of the network node 131 or similar AI functionalities (e.g., more execution-focused functionalities and fewer training-focused functionalities) may be provided by a system node 120 or a UE 110. For example, functionalities that are described as being provided at the network node 131 may additionally or alternatively be provided at a system node 120 or UE 110 as an integrated/imbedded function or dedicated AI function. Moreover, the network node 131 may have its own a sensing functionality and/or dedicated sensing node(s) (not shown) to obtain the sensed information (e.g., network data) for AI operations. In some examples, the network node 131 may be an AI-dedicated node that is capable of performing more intense and/or large amounts of computation (which may be required for comprehensive training of AI models). Further, although illustrated as a single network node 131, it should be understood that the network node 131 may in fact be a representation of a distributed computing system (i.e., the network node 131 may in fact be a group of multiple physical computing systems) and is not necessarily a single physical computing system. It should also be understood that the network node 131 may include future network nodes that may be used in future generation wireless technology.

The system nodes 120 communicate with respective one or more UEs 110 over AN-UE interfaces 125, typically air interfaces (e.g. radio frequency (RF), microwave, infrared (IR), etc.). For example, a RAN-UE interface may be a Uu link (e.g., in accordance with 5G or 4G wireless technologies). The UEs 110 may also communicate directly with one another via one or more sidelink interfaces (not shown). The system nodes 120 each communicate with the core network 130 over AN-core network (CN) interfaces 135 (e.g., NG interfaces, in accordance with 5G technologies). The network node 131 may communicate with the core network 130 over a dedicated interface 145, discussed further below. Communications between the system nodes 120 and the core network 130, between two (or more system nodes 120) and/or between the network node 131 and the core network 130 may be over a backhaul link. Communications in the direction from UEs 110 to system nodes 120 to the core network 130 may be referred to as uplink (UL) communications, and communications in the direction from the core network 130 to system nodes 120 to UEs 110 may be referred to as downlink (DL) communications.

FIG. 1E illustrates an example disclosed architecture in which the AI management module 210 and AI execution modules 220 may be implemented. Other example architectures are now discussed.

FIG. 1F illustrates a wireless system 100B implementing another example network architecture, in accordance with embodiments of the present disclosure. It should be appreciated that the network architecture of FIG. 1F has many similarities with that of FIG. 1E, and details of the common elements need not be repeated.

Compared to the example shown in FIG. 1E, the network architecture of the wireless system 100F of FIG. 1F enables the network node 131, at which the AI management module 210 is implemented, to interface directly with each system node 120 via an interface 147 to each system node 120 (e.g., to at least one system node 120 of each AN). The interface 147 may be a common API interface or a specialized interface dedicated for AI-related communications (e.g., for communications using an AI-related protocol, such as the protocols disclosed herein). It should be noted that the interface 147 enables direct communication between the AI management module 210 and the AI execution module 220 at each system node 120 (regardless of whether the network node 131 is a node in the MEC platform 140 or in an external network 150, or if the network node 131 is part of the core network 130). The interface 147 may be a wired or wireless interface, and may be a backhaul link between the network node 131 and the system node 120, for example. The interface 147 may not be typically found in 4G or 5G wireless systems. The network node 131 in FIG. 1F may also be accessible by the external network(s) 150, the MEC platform 140 and/or the core network 130 (although such links are not shown in FIG. 1F for simplicity).

FIG. 1G illustrates a wireless system 100G implementing another example network architecture, in accordance with embodiments of the present disclosure. It should be appreciated that the network architecture of FIG. 1G has many similarities with that of FIGS. 1E and 1F, and details of the common elements need not be repeated. FIG. 1G illustrates an example architecture in which the AI management module 210 is located in a network node 131 that is physically close to the one or more system nodes 120 of the one or more ANs being managed using the AI management module 210. For example, the network node 131 may be co-located with or within the MEC platform 140, or may be co-located with or within an AN.

Compared to the examples shown in FIGS. 1E and 1F, the network architecture of the wireless system 100G of FIG. 1G omits the AI execution module 220 from the system nodes 120. One or more local AI models (and optionally a local AI database) that would otherwise be maintained at a local memory of each system nodes 120 may be instead maintained at a memory local to the network node 131 (e.g., in a memory of a MEC host, or in a distributed memory on the MEC platform 140). Although not shown in FIG. 1G, the network node 131 may implement one or more AI execution modules 220, or may implement functionalities of the AI execution module 220, in addition to the AI management module 210, for example to enable collection of network data and near-real-time training and execution of AI models, and/or to enable separation of global and local AI models.

Because the network node 131 is located physically close to the system nodes 120, communication between each system node 120 (e.g., from one or more ANs) and the network node 131 may be carried out with very low latency (e.g., latency on the order of only a few microseconds or only a few milliseconds). Thus, communications between the system nodes 120 and the network node 131 may be carried out in near-real-time. Communication between each system node 120 and the network node 131 may be over the interface 147, as described above. The interface 147 may be an AI-dedicated communication interface, supporting low-latency communications.

FIG. 1H illustrates an example apparatus that may implement the methods and teachings according to this disclosure. In particular, FIG. 1H illustrates an example computing system 250, which may be used to implement a UE 110, a system node 120, or a network node 131. As will be discussed further below, the computing system 250 may be specialized, or include specialized components, to support training and/or execution of AI models (e.g., training and/or execution of neural networks).

As shown in FIG. 1H, the computing system 250 includes at least one processing unit 251. The processing unit 251 implements various processing operations of the computing system 250. For example, the processing unit 251 could perform signal coding, data processing, power control, input/output processing, or any other functionality of the computing system 250. In addition, the processing unit 251 may also be configured to implement computations required to train and/or execute an AI model. In some examples, the processing unit 251 may be a specialized processing unit capable of performing a large number of computations for training an AI model. The processing unit 251 may, for example, include a microprocessor, microcontroller, digital signal processor, field programmable gate array, application specific integrated circuit, neural processing unit (NPU), tensor processing unit (TPU), or a graphics processing unit (GPU). In some examples, there may be multiple processing units 251 in the computing system 250, with at least one processing unit 251 being a central processing unit (CPU) responsible for performing core functions of the computing system 250 (e.g., execution of an operating system (OS)), and at least another processing unit 251 being responsible for performing specialized functions (e.g., carrying out computations for training and/or executing an AI model).

The computing system 250 includes at least one communication interface 252 for wired and/or wireless communications. Each communication interface 252 includes any suitable structure for generating signals for wireless or wired transmission and/or processing signals received wirelessly or by wire. The computing system 250 in this example includes at least one antenna 254, for example, for a wireless communication interface 252 (in other examples, the antenna 254 may be omitted, for example, for a wireline communication interface 252). Each antenna 254 includes any suitable structure for transmitting and/or receiving wireless or wired signals. One or multiple communication interfaces 252 could be used in the computing system 250. One or multiple antennas 254 could be used in the computing system 250. In some examples, one or more antennas 254 may be an antenna array, which may be used to perform beamforming and beam steering operations. Although shown as a single functional unit, a communication interface 252 could also be implemented using at least one transmitter interface and at least one separate receiver interface. The processing unit 251 is coupled to the communication interface 252, for example to provide data to be transmitted and/or to receive data via the communication interface 252. The processing unit 251 may also control the operation of the communication interface 252 (e.g., to set parameters for wireless signaling).

The computing system 250 may include one or more optional input/output devices 256. The input/output device(s) 256 permit interaction with a user and/or optionally interaction directly with other nodes such as a UE 110, a system node 120 (e.g., a base station), a network node 131, or a functional node in the core network 130. Each input/output device 256 may include any suitable structure for providing information to or receiving information from a user, such as a speaker, microphone, keypad, keyboard, display, or touchscreen, among other possibilities. The processing unit 251 is coupled to the input/output device(s) 256, for example to provide data to be outputted via an output device or to receive data inputted via an input device.

The computing system 250 includes at least one memory 258. The memory 258 stores instructions and data used, generated and/or collected by the computing system 250. For example, the memory 258 could store software instructions or modules configured to implement some or all of the functionality and/or embodiments described herein. The processing unit 251 is coupled to the memory 258 to enable the processing unit 251 to execute instructions stored in the memory 258, and to store data into the memory 258, for example. The memory 258 may include any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

Reference is again made to FIG. 1A. AI capabilities in the wireless system 100A are supported by functions provided by an AI management module 210, and at least one AI execution module 220. The AI management module 210 and the AI execution module 220 are software modules, which may be encoded as instructions stored in memory and executable by a processing unit.

In the example shown, the AI management module 210 is located in the network node 131, which may be co-located with or located within the MEC 140 (e.g., implemented on a MEC host, or implemented in a distributed manner over multiple MEC hosts). In other examples, the AI management module 210 may be located in the network node 131 that is a node of an external network 150 (e.g., implemented in a network server of the external network 150). In general, the AI management module 210 may be located in any suitable network node 131, and may be located in a network node 131 that is part of or outside of the core network 130. In some examples, locating the AI management module 210 in a network node 131 that is outside of the core network 130 may enable a more open interface with external network(s) 150 and/or third-party services, although this is not necessary. The AI management module 210 may manage a large number of different AI models designed for different tasks, as discussed further below. Although the AI management module 210 is shown within a single network node 131, it should be understood that the AI management module 210 may also be implemented in a distributed manner (e.g., distributed over multiple network nodes 131, or the network node 131 is itself a representation of a distributed computing system).

In this example, each system node 120 implements a respective AI execution module 220. For example, the system node 120 may be a BS within an AN, and may implement the AI execution module 220 and perform the functions of the AI execution module 220 on behalf of the entire AN (or on behalf of a portion of the AN). In another example, each BS within an AN may be a system node 120 that implements its own AI execution module 220. Thus, the multiple system nodes 120 shown in FIG. 1A may or may not belong to the same AN. In another example, the system node 120 may be a separate AI-capable node (i.e., not a BS) in the AN, which may or may not be dedicated to providing AI functionality. Although each AI execution module 220 is shown within a single system node 120, it should be understood that each AI execution module 220 may independently and optionally be implemented in a distributed manner (e.g., distributed over multiple system nodes 120, or the system node 120 itself may be a representation of a distributed computing system).

The AI execution module 220 may interact with some or all software modules of the system node 120. For example, the AI execution module 220 may interface with logical layers such as the physical (PHY) layer, media access control (MAC) layer, radio link control (RLC), packet data convergence protocol (PDCP) layer, and/or upper layers (at the system node 120, the logical layers may be functionally split into higher-level centralized unit (CU) layers and lower-level distributed unit (DU) layers) of the system node 120. For example, the AI execution module 220 may interface with control modules of the system node 120 using a common application programming interface (API).

Optionally, a UE 110 may also implement its own AI execution module 220. The AI execution module 220 implemented by a UE 110 may perform functions similar to the AI execution module 220 implemented at a system node 120. Other implementations may be possible. It should be noted that different UEs 110 may have different AI capabilities. For example, all, some, one or none of the UEs 110 in the wireless system 100A may implement a respective AI execution module 220.

In this example the network node 131 may communicate with one or more system nodes 120 via the core network 130 (e.g., using AMF or/and UPF provided by the core functions 132 of the core network 130). The network node 131 may have a communication interface with the core network 130 using the interface 145, which may be a common API interface or a specialized interface dedicated for AI-related communications (e.g., for communications using a AI-related protocol, such as the protocols disclosed herein). It should be noted that the interface 145 enables direct communication between the network node 131 and the core network 130 (regardless of whether the network node 131 is within, near, or outside of the core network 130), bypassing a convergence interface (which may be typically required in this scenario for communications between the core network 130 and all external networks 150). In another embodiment, the network node 131 is within the core network 130 and the interface 145 is an inter communication interface in the core network 130, such as the common API interface. The interface 145 may be a wired or wireless interface, and may be a backhaul link between the network node 131 and the core network 130, for example. The interface 145 may be an interface not typically found in 4G or 5G wireless systems. The core network 130 may thus serve to forward or relay AI-related communications between the AI execution modules 220 at one or more system nodes 120 (and optionally at one or more UEs 110) and the AI management module 210 at the network node 131. In this way, the AI management module 210 may be considered to provide a set of AI-related functions in parallel with the core functions 132 provided by the core network 130.

AI-related communications between the system node 120 and one or more UEs 110 may be via an interface such as the Uu link in 5G and 4G network systems, or may be via an AI-dedicated air interface (e.g., using an AI-related protocol on an AI-related logical layer, as discussed herein). For example, AI-related communications between a system node 120 and a UE 110 served by the system node 120 may be over an AI-dedicated air interface, whereas non-AI-related communications may be over a 5G or 4G Uu link.

FIG. 1I illustrates a schematic diagram of an example pre-trained big model 100I in accordance with some example embodiments of the present disclosure. The pre-trained big model is also referred to as a global model, or called as foundation model. The pre-trained big model may be deployed at the core network (CN) or a third party to support multiple tasks. The pre-trained big model 100I is utilized here as a basis for AI tasks at the radio access network (RAN) side.

As illustrated in FIG. 1I, the pre-trained big model 100I is pre-trained for a plurality of tasks. When task-1 is input to the pre-trained big model, an inference-1 corresponding to the input task-1 can be obtained. Similarly, when task-2 is input to the pre-trained big model, an inference-2 corresponding to the input task-2 can be obtained. This goes on and on. When task-N(N is an integer larger than 2) is input to the pre-trained big model, an inference-N corresponding to the input task-N can be obtained.

Currently, more and more AI tasks will be in the future network, if for each AI task, RAN node (e.g. BS) trains its own model, the fragmented models are too expensive (because individual hardware should be prepared for each AI model) and not efficient.

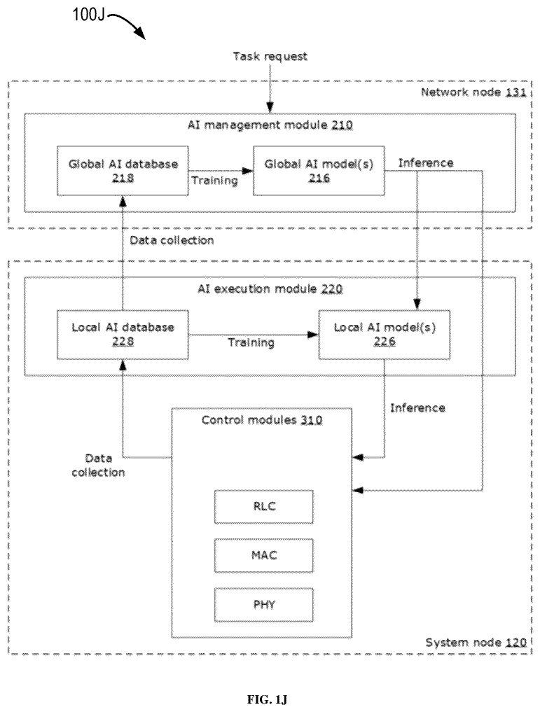

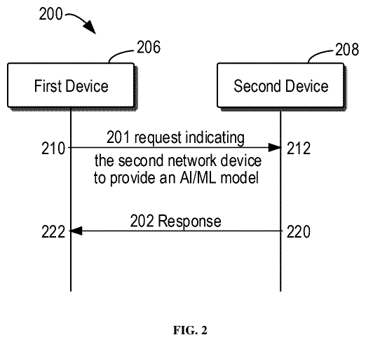

In this circumstance, the RAN side can obtain a basic customized model from the global model (e.g., the customized model is a smaller model than the global model), and perform fine-tuning on the local model. This is the basic technical concept of this disclosure, and will be described in more detail with reference to FIGS. 2-15.

FIG. 1J is a simplified block diagram illustrating an example dataflow in an example operation of the AI management module 210 and the AI execution module 220 as illustrated, for example, in FIGS. 1E and 1F. In this example, the AI execution module 220 is implemented in a system node 120, such as the BS of an AN. It should be understood that similar operations may be carried out if the AI execution module 220 is implemented in a UE 110 (and the system node 120 may be an intermediary to relay the AI-related communications between the UE 110 and the network node 131). Further, communications to and from the network node 131 may or may not be relayed through the core network 130.

A task request is received by the AI management module 210. An example is first described in which the task request is a network task request. The network task request may be any request for a network task, including a request for a service, and may include one or more task requirements, such as one or more KPIs (e.g., latency, QoS, throughput, etc.) and/or application attributes (e.g., traffic types, etc.) related to the network task. The task request may be received from a customer of the wireless system 100E or 100F, from an external network 150, and/or from nodes within the wireless system 100E or 100F (e.g., from the system node 120 itself).

At the AI management module 210, after receiving the task request, the AI management module 210 performs functions (e.g., using functions provided by the AIMF and/or AICF) to perform initial setup and configuration based on the task request. For example, the AI management module 210 may use functions of the AICF to set the target KPI(s) and application or traffic type for the network task, in accordance with the one or more task requirements included in the task request. The initial setup and configuration may include selection of one or more global AI models 216 (from among a plurality of available global AI models 216 maintained by the AI management module 210) to satisfy the task request. The global AI models 216 available to the AI management module 210 may be developed, updated, configured and/or trained by an operator of the core network 130, other operators, an external network 150, or a third-party service, among other possibilities. The AI management module 210 may select one or more selected global AI models 216 based on, for example, matching the definition of each global AI model (e.g., the associated task, the set of input-related attributes and/or the set of output-related attributes defined for each global AI model) with the task request. The AI management module 210 may select a single global AI model 216, or may select plurality of global AI models 216 to satisfy the task request (where each selected global AI model 216 may generate inference data that addresses a subset of the task requirements).

After selecting the global AI model(s) 216 for the task request, the AI management module 210 performs training of the global AI model(s) 216, for example using global data from a global AI database 218 maintained by the AI management module 210 (e.g., using training functions provided by the AIMF). The training data from the global AI database 218 may include non-RT data (e.g., may be older than several milliseconds, or older than one second), and may include network data and/or model data collected from one or more AI execution modules 220 managed by the AI management module 210. After training is complete (e.g., the loss function for each global AI model 216 has converged), the selected global AI model(s) 216 are executed to generate a set of global (or baseline) inference data (e.g., using model execution functions provided by the AIMF). The global inference data may include globally inferred (or baseline) control parameter(s) to be implemented at the system node 120. The AI management module 210 may also extract, from the trained global AI model(s), global model parameters (e.g., the trained weights of the global AI model(s)), to be used by local AI model(s) at the AI execution module 220. The globally inferred control parameter(s) and/or global model parameter(s) are communicated (e.g., using output functions of the AICF) to the AI execution module 220 as configuration information, for example in a configuration message.

At the AI execution module 220, the configuration information is received and optionally preprocessed (e.g., using input functions of the AICF 224). The received configuration information may include model parameter(s) that are used by the AI execution module 220 to identify and configure one or more local AI model(s) 226. For example, the model parameter(s) may include an identifier of which local AI model(s) 226 the AI execution module 220 should select from a plurality of available local AI models 226 (e.g., a plurality of possible local AI models and their unique identifiers may be predefined by a network standard, or may be preconfigured at the system node 120). The selected local AI model(s) 226 may be similar to the selected global AI model(s) 216 (e.g., having the same model definition and/or having the same model identifier). The model parameter(s) may also include globally trained weights, which may be used to initialize the weights of the selected local AI model(s) 226. For example, depending on the task request, the selected local AI model(s) 226 may (after being configured using the model parameter(s) received from the AI management module 210) be executed to generate inferred control parameter(s) for one or more of: mobility control, interference control, cross-carrier interference control, cross-cell resource allocation, RLC functions (e.g., ARQ, etc.), MAC functions (e.g., scheduling, power control, etc.), and/or PHY functions (e.g., RF and antenna operation, etc.), among others.

The configuration information may also include control parameter(s), based on inference data generated by the selected global AI model(s) 216, that may be directly used to configure one or more control modules at the system node 120. For example, the control parameter(s) may be converted (e.g., using output functions of the AICF 224) from the output format of the global AI model(s) 216 into control instructions recognized by the control module(s) at the system node 120. The control parameter(s) from the AI management module 210 may be tuned or updated by training the selected local AI model(s) 226 on local network data to generate locally inferred control parameter(s) (e.g., using model execution functions provided by the AIEF 222). In the example where the AI execution module 220 is implemented at the system node 120, the system node 120 may also communicate control parameter(s) (whether received directly from the AI management module 210 or generated using the selected local AI model(s) 226) to one or more UEs 110 (not shown) served by the system node 120.

The system node 120 may also communicate configuration information to the one or more UEs 110, to configure the UE(s) 110 to collect real-time or near-RT local network data. The system node 120 may also configure itself to collect real-time or near-RT local network data. Local network data collected by the UE(s) 110 and/or the system node 120 may be stored in a local AI database 228 maintained by the AI execution module 220, and used for near-RT training of the selected local AI model(s) 226 (e.g., using training functions of the AIEF 222). As previously mentioned, training of the selected local AI model(s) 226 may be performed relatively quickly (compared to training of the selected global AI model(s) 216) to enable generation of inference data in near-RT as the local data is collected (to enable near-RT adaptation to the dynamic real-world environment). For example, training of the selected local AI model(s) 226 may involve fewer training iterations compared to training of the selected global AI model(s) 216. The trained parameters of the selected local AI model(s) 226 (e.g., the trained weights) after near-RT training on local network data may also be extracted and stored as local model data in the local AI database 228.

In some examples, one or more of the control modules at the system node 120 (and optionally one or more UEs 110 served by the RAN 120) may be configured directly based on the control parameter(s) included in the configuration information from the AI management module 210. In some examples, one or more of the control modules at the system node 120 (and optionally one or more UEs 110 served by the RAN 120) may be controlled based on locally inferred control parameter(s) generated by the selected local AI model(s) 226. In some examples, one or more of the control modules at the system node 120 (and optionally one or more UEs 110 served by the RAN 120) may be controlled jointly by the control parameter(s) from the AI management module 210 and by the locally inferred control parameter(s).

The local AI database 228 may be a shorter-term data storage (e.g., a cache or buffer), compared to the longer-term data storage at the global AI database 218. Local data maintained in the local AI database 228, including local network data and local model data, may be communicated (e.g., using output functions provided by the AICF 224) to the AI management module 210 to be used for updating the global AI model(s) 216.

At the AI management module 210, local data collected from one or more AI execution modules 220 are received (e.g., using input functions provided by the AICF) and added, as global data, to the global AI database 218. The global data may be used for non-RT training of the selected global AI model(s) 216. For example, if the local data from the AI execution module(s) 220 include the locally-trained weights of the local AI model(s) (if the local AI model(s) have been updated by near-RT training), the AI management module 210 may aggregate the locally-trained weights and use the aggregated result to update the weights of the selected global AI model(s) 216. After the selected global AI model(s) 216 have been updated, the selected global AI model(s) 216 may be executed to generate updated global inference data. The updated global inference data may be communicated (e.g., using output functions provided by the AICF) to the AI execution module 220, for example as another configuration message or as an update message. In some examples, the update message communicated to the AI execution module 220 may include only control parameters or model parameters that have changed from the previous configuration message. The AI execution module 220 may receive and process the updated configuration information in the manner described above.

In the example illustrated in FIG. 1J, the AI management module 210 performs continuous data collection, training of selected global AI model(s) 216 and execution of the trained global AI model(s) 216 to generate updated data (including updated globally inferred control parameter(s) and/or global model parameter(s)), to enable continuous satisfaction of the task request (e.g., satisfaction of one or more KPIs included as task requirements in the task request). The AI execution module 220 may similarly perform continuous updates of configuration parameter(s), continuous collection of local network data and optionally continuous training of the selected local AI model(s) 226, to enable continuous satisfaction of the task request (e.g., satisfaction of one or more KPIs included as task requirements in the task request). As illustrated in FIG. 1J, collection of local network data, training of global (or local) AI model(s) and generation of updated inference data (whether global or local) may be performed repeatedly as a loop, at least for the time duration indicated in the task request (or until the task request is updated or replaced), for example.

Another example is now described in which the task request is a collaborative task request. For example, the task request may be a request for collaborative training of an AI model, and may include an identifier of the AI model to be collaboratively trained, an identifier of data to be used and/or collected for training the AI model, a dataset to be used for training the AI model, locally trained model parameters to be used for collaboratively updating a global AI model, and/or a training target or requirement, among other possibilities. The task request may be received from a customer of the wireless system 100E or 100F, from an external network 150, and/or from nodes within the wireless system 100E or 100F (e.g., from the system node 120 itself).

At the AI management module 210, after receiving the task request, the AI management module 210 performs functions (e.g., using functions provided by the AIMF and/or AICF) to perform initial setup and configuration based on the task request. For example, the AI management module 210 may use functions of the AICF to select and initialize one or more AI models in accordance with the requirements of the collaborative task (e.g., in accordance with an identifier of the AI model to be collaboratively trained and/or in accordance with parameters of the AI model to be collaboratively updated).

After selecting the global AI model(s) 216 for the task request, the AI management module 210 performs training of the global AI model(s) 216. For collaborative training, the AI management module 210 may use training data provided and/or identified in the task request for training of the global AI model(s) 216. For example, the AI management module 210 may use model data (e.g., locally trained model parameters) collected from one or more AI execution modules 220 managed by the AI management module 210 to update the parameters of the global AI model(s) 216. In another example, the AI management module 210 may use network data (e.g., locally generated and/or collected user data) collected from one or more AI execution modules 220 managed by the AI management module 210, to train the global AI model(s) 216 on behalf of the AI execution module(s) 220. After training is complete (e.g., the loss function for each global AI model 216 has converged), model data extracted from the selected global AI model(s) 216 (e.g., the globally updated weights of the global AI model(s)) may be communicated to be used by local AI model(s) at the AI execution module 220. The global model parameter(s) may be communicated (e.g., using output functions of the AICF) to the AI execution module 220 as configuration information, for example in a configuration message.

At the AI execution module 220, the configuration information includes model parameter(s) that are used by the AI execution module 220 to update one or more corresponding local AI model(s) 226 (e.g., the AI model(s) that are the target(s) of the collaborative training, as identified in the collaborative task request). For example, the model parameter(s) may include globally trained weights, which may be used to update the weights of the selected local AI model(s) 226. The AI execution module 220 may then execute the updated local AI model(s) 226. Additionally or alternatively, the AI execution module 220 may continue to collect local data (e.g., local raw data and/or local model data), which may be maintained in the local AI database 228. For example, the AI execution module 220 may communicate newly collected local data to the AI management module 210 to continue the collaborative training.

At the AI management module 210, local data collected from one or more AI execution modules 220 are received (e.g., using input functions provided by the AICF) and may be used for collaborative of the selected global AI model(s) 216. For example, if the local data from the AI execution module(s) 220 include the locally-trained weights of the local AI model(s) (if the local AI model(s) have been updated by near-RT training), the AI management module 210 may aggregate the locally-trained weights and use the aggregated result to collaboratively update the weights of the selected global AI model(s) 216. After the selected global AI model(s) 216 have been updated, updated model parameters may be communicated back to the AI execution module 220. This collaborative training, including communications between the AI management module 210 and the AI execution module 220, may be continued until an end condition is met (e.g., the model parameters have sufficiently converged, the target optimization and/or requirement of the collaborative training has been achieved, expiry of a timer, etc.). In some examples, the requestor of the collaborative task may transmit a message to the AI management module 210 to indicate that the collaborative task should end.

It may be noted that, in some examples, the AI management module 210 may participate in a collaborative task without requiring detailed information about the data being used for training and/or the AI model(s) being collaboratively trained. For example, the requestor of the collaborative task (e.g., the system node 120 and/or the UE 110) may define the optimization targets and/or may identify the AI model(s) to be collaboratively trained, and may also identify and/or provide the data to be used for training. In some examples, the AI management module 210 may be implemented by a node that is a public AI service center (or a plug-in AI device), for example from a third-party, that can provide the functions of the AI management module 210 (e.g., AI modeling and/or AI parameter training functions) based on the related training data and/or the task requirements in a request from a customer or a system node 120 (e.g., BS) or UE 110. In this way, the AI management module 210 may be implemented as an independent and common AI node or device, which may provide AI-dedicated functions (e.g., as an AI modeling training tool box) for the system node 120 or UE 110. However, the AI management module 210 might not be directly involved in any wireless system control. Such implementation of the AI management module 210 may be useful if a wireless system wishes or requires its specific control goals to be kept private or confidential but requires AI modeling and training functions provided by the AI management module 210 (e.g., the AI management module 210 need not even be aware of any AI execution module 220 present in the system node 120 or UE 110 that is requesting the task).

Some examples of how the AI management module 210 cooperates with the AI execution module 220 to satisfy a task request are now described. It should be understood that these examples are not intended to be limiting. Further, these examples are described in the context of the AI execution module 220 being implemented at the system node 120. However, it should be understood that the AI execution module 220 may additionally or alternatively be implemented at one or more UEs 110.

An example network task request may be a request for low latency service, such as to service URLLC traffic. The AI management module 210 performs initial configuration to set a latency constraint (e.g., maximum 2 ms delay in end-to-end communication) in accordance with this network task. The AI management module 210 also selects one or more global AI models 216 to address this network task, for example a global AI model associated with URLLC is selected. The AI management module 210 trains the selected global AI model 216, using training data from the global AI database 218. The trained global AI model 216 is executed to generate global inference data that includes global control parameters that enable high reliability communications (e.g., an inferred parameter for a waveform, an inferred parameter for interference control, etc.). The AI management module 210 communicates a configuration message to the AI execution module 220 at the system node 120, including globally inferred control parameter(s) and model parameter(s). The AI execution module 220 outputs the received globally inferred control parameter(s) to configure the appropriate control modules at the system node 120. The AI execution module 220 also identifies and configures the local AI model 226 associated with URLLC, in accordance with the model parameter(s). The local AI model 226 is executed to generate locally inferred control parameter(s) for the control modules at the system node 120 (which may be used in place of or in addition to the globally inferred control parameter(s)). For example, control parameter(s) that may be inferred to satisfy the URLLC task may include parameters for a fast handover switching scheme for URLLC, an interference control scheme for URLLC, a defined cross-carrier resource allocation (to reduce cross-carrier interference), the RLC layer may be configured with no ARQ (to reduce latency), the MAC layer may be configured to use grant-free scheduling or a conservative resource configuration with power control for uplink communications, and the PHY layer may be configured to use an URLLC-optimized waveform and antenna configuration. The AI execution module 220 collects local network data (e.g., channel status information (CSI), air-link latencies, end-to-end latencies, etc.) and communicates the local data (which may include both the collected local network data and the local model data, such as the locally trained weights of the local AI model 226) to the AI management module 210. The AI management module 210 updates the global AI database 218 and performs non-RT training of the global AI model 216, to generate updated inference data. These operations may be repeated to continue satisfying the task request (i.e., enabling URLLC).

Another example network task request may be a request for high throughput, for file downloading. The AI management module 210 performs initial configuration to set a high throughput requirement (e.g., high spectrum efficiency for transmissions) in accordance with this network task. The AI management module 210 also selects one or more global AI models 216 to address this network task, for example a global AI model associated with spectrum efficiency is selected. The AI management module 210 trains the selected global AI model 216, using training data from the global AI database 218. The trained global AI model 216 is executed to generate global inference data that includes global control parameters that enable high spectrum efficiency (e.g., efficient resource scheduling, multi-TRP handover scheme, etc.). The AI management module 210 communicates a configuration message to the AI execution module 220 at the system node 120, including globally inferred control parameter(s) and model parameter(s). The AI execution module 220 outputs the received globally inferred control parameter(s) to configure the appropriate control modules at the system node 120. The AI execution module 220 also identifies and configures the local AI model 226 associated with spectrum efficiency, in accordance with the model parameter(s). The local AI model 226 is executed to generate locally inferred control parameter(s) for the control modules at the system node 120 (which may be used in place of or in addition to the globally inferred control parameter(s)). For example, control parameter(s) that may be inferred to satisfy the high throughput task may include parameters for a multi-TRP handover scheme, an interference control scheme for model interference control, a carrier aggregation and dual connectivity multi-carrier scheme, the RLC layer may be configured with a fast ARQ configuration, the MAC layer may be configured to use an aggressive resource scheduling and power control for uplink communications, and the PHY layer may be configured to use an antenna configuration for massive MIMO. The AI execution module 220 collects local network data (e.g., actual throughput rate) and communicates the local data (which may include both the collected local network data and the local model data, such as the locally trained weights of the local AI model 226) to the AI management module 210. The AI management module 210 updates the global AI database 218 and performs non-RT training of the global AI model 216, to generate updated inference data. These operations may be repeated to continue satisfying the task request (i.e., enabling high throughput).

FIG. 2 illustrates a signaling chart illustrating an example communication process 200 in accordance with some example embodiments of the present disclosure. Only for the purpose of discussion, the communication process 200 will be described with reference to FIGS. 1A-1J. The communication process 200 may involve a first device 206 and a second device 208. The first device 206 is an example of ED 110 or RAN 120a (or 120b or 120c) at the RAN side as illustrated in FIG. 1B. When the first device 206 is an example of ED 110, the second device 208 is an example of RAN 120a (or 120b or 120c) at the RAN side or CN 130 at the CN side as illustrated in FIG. 1B or a third party (for example, the MEC platform 140 as illustrated in FIGS. 1E, 1F and 1G). When the first device 206 is an example of RAN 120a (or 120b or 120c), the second device 208 is an example of CN 130 at the CN side as illustrated in FIG. 1B or a third party (for example, the MEC platform 140 as illustrated in FIGS. 1E, 1F and 1G).

As illustrated in FIG. 2, the first device 206 transmits (210), to the second device 208, a request 201 indicating the second device 208 to provide an (AI/ML model. On the other side of communication, the second device 208 receives (212), from the first device 206, the request 201. Here, the request 201 comprises at least one of a request identifier (ID), information of a task, a first parameter of input data of the AI/ML model, or a second parameter of output data of the AI/ML model. Upon receipt of the request 201, the second device 208 transmits (220) a response 202 to the first device 206. On the other side of communication, the first device 206 receives (222) the response 202 from the second device 208. For example, the response may comprise the request ID and one of an acknowledgement (ACK) or a negative acknowledgement (NACK). In this way, the first device 206 can know whether the requested AI/ML model is available or not.

Specifically, the information may comprise a task index indicative of a row of a task table. In addition or as an alternative, the information may comprise a key performance indicator (KPI) index indicative of a KPI requirement for the task, where the KPI index indicates a row of a KPI table. In addition or as an alternative, the information may comprise a scenario index indicative of a scenario in which the task is to be performed, where the scenario index indicates a row of a scenario table. In this way, the first device 206 can specify some requirements for the desired AI/ML model in the request, in an explicit manner, so as to an AI/ML model which meets the requirements specified by the first device 206 can be obtained from the second device 208.

The task index may indicate a group of functions of an AI/ML model and an achievable performance of the AI/ML model. In this way, the first device 206 can specify some requirements for the desired AI/ML model in the request, in an implicit manner with the task index, so as to an AI/ML model which meets the requirements specified by the first device 206 can be obtained from the second device 208.

In addition or as an alternative, the task index may indicate at least one radio resource control (RRC) parameter related to an AI/ML model and a function of the AI/ML model. In this way, the first device 206 can specify some requirements for the desired AI/ML model in the request, so as to an AI/ML model which meets the requirements specified by the first device 206 can be obtained from the second device 208.

The KPI requirement may comprise a performance requirement, an overhead requirement, an inference complexity requirement for an AI/ML model, a training complexity requirement for the AI/ML model, or any combination of the above-mentioned options. In this way, the first device 206 can specify some KPI requirement for the desired AI/ML model in the request, so as to an AI/ML model which meets the KPI requirement can be obtained from the second device 208.

The scenario may comprise an urban outdoor scenario. Alternatively, the scenario may comprise an urban indoor scenario. In addition or as an alternative, the scenario may comprise a rural scenario. In addition or as an alternative, the scenario may comprise a highway scenario. In addition or as an alternative, the scenario may comprise a line-of-sight (LOS) scenario. In addition or as an alternative, the scenario may comprise a non-line-of-sight (NLOS) scenario. In addition or as an alternative, the scenario may comprise a windy scenario. In addition or as an alternative, the scenario may comprise a rainy scenario. In this way, the first device 206 can specify a desired scenario (via a scenario index) for the desired AI/ML model in the request, so as to an AI/ML model which is suitable for the scenario can be obtained from the second device 208.

The first parameter may comprise a data type. In addition or as an alternative, the first parameter may comprise a data dimension. In addition or as an alternative, the first parameter may comprise a data granularity. The same is true for the second parameter. In other words, the second parameter may comprise a data type. In addition or as an alternative, the second parameter may comprise a data dimension. In addition or as an alternative, the second parameter may comprise a data granularity. In this way, the first device 206 can specify a desired data type and/or data dimension and/or data granularity for the desired AI/ML model in the request, so as to an AI/ML model which meets the desired data type and/or data dimension and/or data granularity can be obtained from the second device 208.

If the first device 206 needs to perform a plurality of tasks with a plurality of AI/ML models, the first device 206 may request the plurality of AI/ML models with a plurality of request IDs, among which the request ID of request 201 may be one of the plurality of request IDs, and the plurality of request IDs may indicate a plurality of requests transmitted from the first device 206 to the second device 208 for requesting a plurality of respective AI/ML models. In this way, the first device 206 can request a plurality of respective AI/ML models via a single request (here, the request 201), reducing communication overhead as compared with a case where the request for each of the plurality of AI/ML models are transmitted separately.

The response 202 may comprise the ACK, and the response 202 may further indicate a common AI/ML model, where in the response 202 the common AI/MI model is associated with the plurality of request IDs. Alternatively, the response 202 may further indicate the plurality of respective AI/ML models among which an AI/ML model has a first model part and a second model part, the first model part is common to the plurality of respective AI/ML models, and the second model part is different from other AI/ML models among the plurality of respective AI/ML models. In this way, multiple AI/ML models can be feedback from the second device 208 to the first device 206 in a single response (here, response 202), reducing communication overhead as compared with a case where each of the multiple AI/ML models is transmitted separately.

Alternatively, the response 202 may indicate an AI/ML model, where in the response 202 the AI/ML model is associated with the ACK and at least one request IDs of the plurality of request IDs. In addition or as an alternative, the response 202 may indicate the NACK indicating no AI/ML model is available at the second device for at least one request IDs of the plurality of request IDs. In this way, the response (here, response 202) can indicate a case where for multiple request IDs in the request 202, in the response 202 an AI/ML model is feedback with respect to a first request ID among the multiple request IDs, while a NACK is feedback with respect to a second request ID among the multiple request IDs. In other words, the second device 208 can respond to the request 201 from the first device 206 as per request ID in the request 201, and provide AI/ML model(s) requested by the first device 206 to the most extent of the capability of the second device 208.

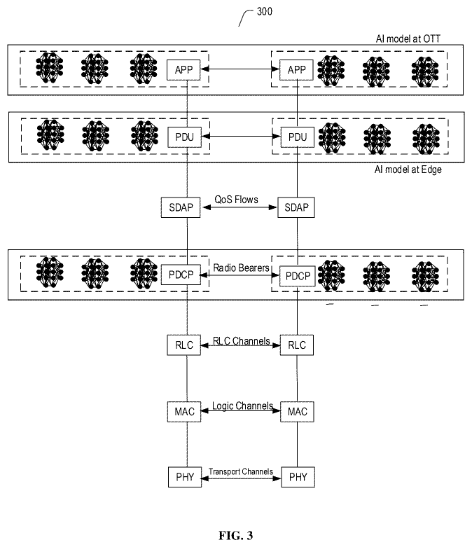

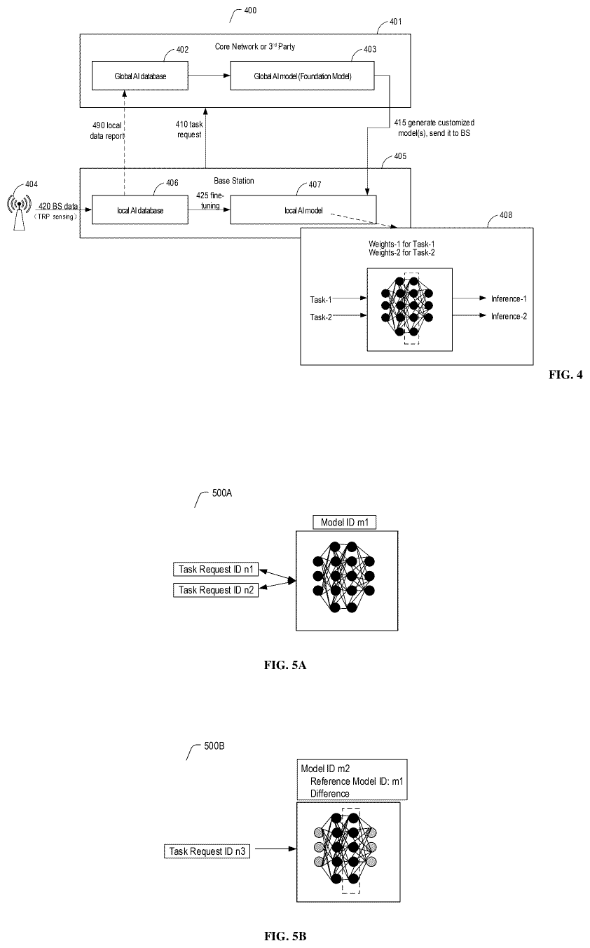

Alternatively, the response 202 may comprise the ACK, and the response 202 may further comprise a model ID of the AI/ML model. In addition or as an alternative, the response 202 may further comprise a model structure of the AI/ML model. In addition or as an alternative, the response 202 may further comprise at least one model parameter of the AI/ML model. In addition or as an alternative, the response 202 may further comprise an indication of whether the AI/ML model is a differential model or a whole model, which will be described in more detail with reference to FIGS. 5A and 5B. In this way, provision of the AI/ML model(s) from the second device 208 to the first device 206 can be more flexible and in more granularities.

More specifically, the indication may be indicative of a differential model, and the response 202 may further comprise a model ID of a reference model, information indicative of one or more model parameters of the AI/ML model which are different from the reference AI/ML model, and one or more values of the one or more model parameters of the AI/ML model. In this way, for an AI/ML model having a common part and a different part from a reference AI/ML model, the second device 208 does not need to transmit the whole AI/ML model to the first device 206; instead, a model ID of the reference AI/ML model, information indicative of one or more parameters of the AI/ML model and one or more values of the one or more model parameters will suffice for the second device 208 to indicate the AI/ML model to the first device 206. Therefore, communication overhead can be reduced as compared with a case where a whole AI/ML model, instead of a differential AI/ML model, is transmitted from the second device 208 to the first device 206.

Additionally, the first device 206 may further perform fine-tuning on the AI/ML model to obtain a fine-tuned AI/ML model, and provide input data to the fine-tuned AI/ML model to obtain a first output. Then, the first device 206 may obtain a second output of a pre-trained AI/ML model to which the input data is provided. Here, the AI/ML model is generated from the pre-trained AI/ML model which is stored at the second device 208. Here, in obtaining the second output of the pre-trained AI/ML model, the first device 206 may transmit the input data (for example, in a format of embedding data) to the second device 208. On the other side of communication, the second device 208 may receive the input data from the first device 206. Then, the second device 208 may provide the input data to a local AI/ML model to obtain a second output (here, the AI/ML model being generated based on the local AI/ML model), and then transmits the second output to the first device 206. Then, upon receipt of the second output from the second device 208, the first device 206 may monitor inference performance of the fine-tuned AI/ML model based on the first output and the second output. In this way, output from the pre-trained big model (which is used as a standard AI/ML model) can be obtained to be compared with a local output at the first device 206 to determine whether inference performance of the local AI/ML model at the first device 206 is good enough. Therefore, inference performance (in other words, accuracy) of the local AI/ML model at the first device 206 can be monitored.

More specifically, the first device 206, as a RAN node (BS or UE), after local model training by the assistance of the global AI model (foundation model), needs to monitor the local AI/ML model to identify the inference performance of the local AI/ML model. During the local model inference at the first device 206 which is an RAN node, the first device 206 may send an input data in the format of embedding data (which is a transformation of original data to protect data privacy) to the global AI model (for example, the global AI model 403 as illustrated in FIG. 4) at the second device 208. At the global AI model, for the input data reported from the first device 206, the global AI model generates the global inference data, which is the soft output of the global AI model and can be regarded as the foundation labels. For example, for classification problem, the foundation label is the probability for each class. Then the global AI model sends the foundation labels to the first device 206. The first device 206 determines the difference of local model soft output and the foundation label for the same input data. For example, the difference can be Euclidean distance between the local model soft output and the foundation label for the same input data. When the difference is larger than a (pre) defined or (pre) configured threshold for a time window (the time window length may also be (pre) defined or (pre) configured in a 3GPP specification or by a network device, for example, by a base station), the first device 206 considers that the accuracy of the local AI/ML model currently in use deteriorates, and may determine not to use the current AI/ML model any more. So, the first device 206 may switch its local AI/ML model currently in use to another local AI/ML model, or fallback to non-AI mode. Optionally, the first device 206 may report corresponding local data (whose local model output has bigger difference than global AI model output) to global AI database, so as to achieve better generalization performance at the global AI model. In addition or as an alternative, the first device 206 may perform model fine-tuning locally at the RAN node according to the foundation labels from the global AI model and the ground truth labels.

For example, in order to monitor the inference performance, the first device 206 may determine a difference between the first output and the second output. In this way, inference performance (in other words, accuracy) of the local AI/ML model at the first device 206 can be monitored in the form of the difference between the first output and the second output.

Based on determining that the difference is greater than a threshold, the first device 206 may perform further fine-tuning on the fine-tuned AI/ML model. In addition or as an alternative, the first device 206 may switch to another AI/ML model at the first device 206. In addition or as an alternative, the first device 206 may perform the task without using an AI/ML model. In this way, if the difference is greater than a threshold (i.e., the accuracy of the local AI/ML model at the first device 206 deteriorates to be greater than the threshold), the first device 206 can either no longer use the current AI/ML model any more, or perform further fine-tuning on the AI/ML model first to improve the accuracy of the AI/ML model to be accurate enough before continuing to perform the task.

Based on determining that the difference is greater than the threshold, the first device 206 may further transmit local data at the first device 110 to the second device 208. In this way, the first device 206 can rely on the second device 208 to, with help of the data received from the first device 206, provide another AI/ML model which is more suitable for the first device 206 to perform local tasks.

In the example illustrated in FIG. 2, the first device may be a network device (for example, network device 120a, 120b or 120c as illustrated in FIG. 1B) at the RAN side, and the second device 208 is a network device (for example, core network 130 as illustrated in FIG. 1B) at the CN side. However, the present disclosure is not limited thereto. The first device may also be a terminal device, for example, terminal device 110a, 110b, 110c or 110d as illustrated in FIG. 1B. In such a case, the second device may be an access network device (for example, network device 120a, 120b or 120c as illustrated in FIG. 1B), or a core network device (for example, core network 130 as illustrated in FIG. 1B), or a third party device (for example, MEC platform 140 as illustrated in FIGS. 1E, 1F and 1G). Also, when the first device is an access network device (for example, network device 120a, 120b or 120c as illustrated in FIG. 1B), the second device may also be a third party device (for example, MEC platform 140 as illustrated in FIGS. 1E, 1F and 1G), instead of a core network device. In this way, AI/ML model transfer becomes more flexible and convenient between the first and second devices (for example, core network 130 as illustrated in FIG. 1B).

In this way, according to communication process 200, a relatively light-weighted customized local AI/ML model can be obtained from a rather big (and “heavy”) global foundation model at the second device, reducing the training complexity at the first device. Meanwhile, the local AI/ML model at the first device is more accurate, thus the first device can perform tasks more accurately.

FIG. 3 illustrates a schematic diagram of an example AI model implementation 300 in accordance with some embodiments of the present disclosure. As illustrated in FIG. 3, an AI model can be implemented at various locations. For example, an AI model can be implemented at OTT (over-the-top), at Edge, at BS, or at UE. AI model at OTT is in the application layer of the OSI (open systems interconnections) model, AI model at Edge is in the PDU (packet data unit) layer, and AI model at RAN (BS or UE) may be in SDAP (service data adaptation protocol) layer, PDCP (packet data convergence protocol) layer, RLC (radio link control) layer, MAC (media access control) layer or PHY (physical) layer.

FIG. 4 illustrates a signaling chart illustrating another example communication process 400 in accordance with some embodiments of the present disclosure. In the communication process 400, a first node receives at least one customized AI model from a second node, and performs fine-tuning on the customized AI model at the RAN node. AI Execution Function (AIEF) is located in the first node, and AI Management Function (AIMF) is located in the second node. For the purpose of discussion, the communication process 400 will be described with reference to FIGS. 1A-1J and 2. The RAN node may be a network device (for example, a base station, such as the base station 120a or 120b as illustrated in FIG. 1B) or a terminal device (for example, UE 110a or 110b as illustrated in FIG. 1Bo. The second node may be a core network (CN) or the 3^{rd} party. In case the first node is a terminal device, the second node may also be a base station. For purpose of discussion, the communication process 400 will be described with reference to FIGS. 1A-1J and 2, and it is assumed that the first node is a base station (for example, base station 120a as illustrated in FIG. 1B) at the RAN side, and the second node is a CN or 3^{rd} party. In this case, AI Execution Function (AIEF) is located in the RAN node, and AI Management Function (AIMF) is located in the CN or 3^{rd} party.

In FIG. 4, the global AI model (foundation model) 403 is an example of the pre-trained big model 100I as illustrated in FIG. 1I, and is implemented in a core network or 3^{rd} party 401, which is an example of the second device 208 as illustrated in FIG. 2. A global AI database (DB) 402 for the global AI model 403 is also implemented in the core network or 3^{rd} party 401. At the RAN side, there is a network device 404. The network device 404 may be, for example, a transmit and receive point (TRP). A local AI model is deployed at the base station (BS) 405 (which is an example of the first device 206 as illustrated in FIG. 2). The base station 405 is in connection with the network device 404, directly or indirectly. There is also a local AI database 406 for the local AI model 407 implemented at the base station 405. For clarity, the local AI model 407 may be enlarged as model 408. It is clear as compared with FIG. 1I that, model 408 at the base station 405 is smaller and simpler than the pre-trained big model (here, in FIG. 4, the global AI model 403). This is because that, at the base station 405, the number of tasks to be performed (here, in FIG. 4, task-1 and task-2) is much less than the number of tasks for which the global AI model is pre-trained.

Specifically, at 410, the base station 405, as an RAN node, sends one or multiple task requests to the CN or 3^{rd} party 401, to request the CN or 3^{rd} party 401 to provide a corresponding AI model to the base station 405. On the other side of communication, the CN or 3^{rd} party 401 receives the task request. It is to be noted that, in this example as illustrated in FIG. 4, the task request is sent from a base station (here, the base station 405) at RAN to the CN or 3^{rd} party 401; however, the task request may also be sent from a terminal device (for example, terminal device 110a as illustrated in FIGS. 1A and 1B) to the CN or 3^{rd} party 401 where the global AI model 403 is implemented.

The task request may comprise a task index. In one example, a task indicated in the task request may be defined using an AI/ML feature group. The following Table 1 gives an example of a task table. The task table may be (pre) defined or (pre) configured by the base station, each row of the table has a unique task index. A feature group defines the AI/ML model functionality and its components, e.g. the achievable performance of the AI/ML model indicated by the corresponding task index.

TABLE 1

| Task | Feature group | |
|---|---|---|
| Index | (functionality) | Components |
| 1 | AI/ML based beam | 1) can perform T(ms) prediction |
| | prediction in | 2) configuration of Set A is beams on slot |
| | temporal domain | n1, and Set B is beams on slot n2. |
| 2 | AI/ML based beam | can use N₁ (N₁ > 1) ports beam information |
| | prediction in | to predict N₂ (N₂ > 1) ports beam. |
| | spatial domain | information |

In another example, a task indicated in the task request may be defined using a radio resource control (RRC) signaling. Specifically, in this case, the RRC signaling may comprise AI/ML model related RRC parameters (such as required reference signal (RS) configuration, Set A/B, Top-K, etc.) and AI/ML features which the base station 405, as the requesting party for the AI/ML model, wants the AI/ML model have.

In either case, a task may be associated with a task index.

In addition or as an alternative, the task request may comprise a KPI index indicative of a KPI requirement for the task, the KPI index indicates a row of a KPI table. As the KPI requirement, there may be one or more of performance requirement(s), overhead requirement(s), inference complexity requirement(s), or training complexity requirement(s). Among which, performance may comprise link level performance and/or system level performance. Overhead may comprise overhead of assistance information and/or data collection. Inference complexity may include FLOPs (Floating-point Operations Per second) and/or memory storage and/or model management complexity and/or latency and/or power consumption and/or hardware requirement. Training complexity may include FLOPs and/or number of iterations and/or convergence time and/or memory usage.

The following Table 2 is a KPI table, which may be (pre) defined or (pre) configured by the base station 405. A row of the table has a unique KPI index, the columns of the table include one or multiple of the performance, overhead, inference complexity, or training complexity. So by indicating the KPI index, the UE or BS knows its corresponding KPI requirements.

TABLE 2

| KPI | | | |
|---|---|---|---|
| Index | performance | overhead | complexity |
| KPI-1 | can perform N₃ (N₃ > 1) tasks | time overhead is below 30 ms and | O(2\hat{ }N) |
| | with N₃ UEs in parallel. | memory overhead is below 500 MB. | |
| KPI-2 | can perform N₄ (N₄ > 1) tasks | time overhead is below 20 ms and | O(2\hat{ }(N − 1)) |
| | with N₄ UEs in parallel. | memory overhead is below 300 MB. | |

In addition or as an alternative, the task request may comprise a scenario index indicative of a scenario in which the task is to be performed, the scenario index indicates a row of a scenario table. The following Table 3 is an example of a scenario table, which may be (pre) defined or (pre) configured by the base station 405. A row of the table has a unique scenario index, and the columns of the table may one or more of an urban outdoor scenario, an urban indoor scenario, a rural scenario, a highway scenario, a line-of-sight (LOS) scenario, a non-line-of-sight (NLOS) scenario, a windy scenario, or a rainy scenario.

TABLE 3

| Scenario Index | Urban, rural, highway, etc. |
|---|---|
| 1 | an urban outdoor scenario |
| 2 | an urban indoor scenario |
| 3 | a rural scenario |
| 4 | a highway scenario |
| 5 | a LOS scenario |
| 6 | a NLOS scenario |
| 7 | a windy scenario |
| 8 | a rainy scenario |

In addition or as an alternative, the task request may comprise a first parameter of input data of the AI/ML model. The first parameter may include at least one of a data type, a data dimension, or a data granularity. In addition or as an alternative, the task request may comprise a second parameter of output data of the AI/ML model. The second parameter may include at least one of a data type, a data dimension, or a data granularity.

As the task request contents, when a RAN node (i.e., a base station (here, the base station 405), or a terminal device) sends a task request to a second node (e.g., CN or 3^{rd} party (here, the CN or 3^{rd} party 401), or a base station), the task request may include one or more task request ID(s) which is used to identify the task, and task details associated to this task request ID(s), i.e., for each task request ID in the task request, one or multiple of a task index, a KPI index, a scenario index, an input parameter (which includes at least one of input data type, dimension or granularity), or an output parameter (which includes at least one of input data type, dimension or granularity). The RAN node could send one or multiple task requests, each may have a (unique) task request ID.

Reference is now made back to FIG. 4. At the CN or 3^{rd} party 401, upon receipt of the one or multiple task requests, at 415, the CN or 3^{rd} party 401 generates one or more customized AI models, and send it (them), as a (task) response to the task response at 410, to the base station 405. Here, if there are more than one customized AI model for the CN or 3^{rd} party 401 to send to the base station 405, the customized AI models may have small difference in partial parameters. As shown in FIG. 4, the parameters of models for Task-1 and Task-2 are different in one layer, so the indication can be weights-1 for Task-1 and weights-2 for Task-2 in that different layer. For other parameters, one indication is enough, since the parameters are same for the two tasks and can be commonly used.

Specifically, the task response may be sent from a second node (for example, a CN or 3^{rd} party (here, the CN or third party 401), or a base station) to a first node (for example, a base station (here, the base station 405) or a terminal device). The task response may include task request ID(s) and/or task ACK/NACK. The task request ID in the task response indicates that the response is for which task request ID(s). If there are multiple IDs in this field, multiple tasks will share the same AI/ML model, or the models for multiple tasks have minor difference, e.g. only parameters of some NN layers of the AI/ML model are different. If the task ACK/NACK in the task response has an “ACK” value, the task response indicates, in the task response, model ID of the corresponding AI/ML model to identify the AI/ML model, AI/ML model structure, parameters, and a differential model or whole model indication. If the AI/ML model is a differential model, the task response further indicates the reference model ID and differential value (including which layers/neurons are different, and the difference value). The reference model ID may indicate a whole model. The second node (here, the base station 405) may, on receipt of the task response, restore a whole AI/ML model from the indicated differential model, for example, by applying the indicated differential value to the reference model indicated by the reference model ID. This will be described in more detail with reference to FIGS. 5A and 5B.

At 420, the base station 405 collects the training data, for example, by TRP (transmission reception point) sensing or TRP measurement. The base station 405 may store the collected training data in the local AI database 406. Then, at 425, the base station 405 may use the collected training data to perform fine-tuning on the one or more customized AI models received from the CN or 3^{rd} party 401. Through the fine-tuning, a fine-tuned AI model can be obtained from the customized AI model, and the base station 405 may use the fine-tuned AI model to execute a local AI task, for example, task-1 and/or task-2 as illustrated in FIG. 4.

Optionally, at 490, the base station 405 may send the locally collected training data in the local AI database 406 to the global AI database 402, such that the CN or 3^{rd} party 401 may use the training data, for example, to fine-tune and update the global AI model 403.

It is to be noted that although the communication process 400 is described assuming that the first node is a base station (here, base station 405) at the RAN side, and the second node is a CN or 3^{rd} party (here, CN or 3^{rd} party 401), however, as mentioned above, the first node may also a terminal device (for example, the terminal device 110a, 110b, 110c, or 110d as illustrated in FIG. 1B) at the RAN side, in which case the second node may be a CN or 3^{rd} party (for example, CN or 3^{rd} party 401 in this example), or may also be a network device at the RAN side, for example, network device 120a, 120b or 120c as illustrated in FIG. 1B.

In this way, a relatively light-weighted customized local AI/ML model 407 meeting requirements specified by the base station 405 can be obtained from a rather big (and “heavy”) global foundation model 403 at the CN or 3^{rd} party 401, reducing the training complexity at the base station 405. Meanwhile, the local AI/ML model 407 at the base station 405 is more accurate, thus the base station 405 can perform tasks more accurately.

FIG. 5A illustrates a schematic diagram illustrating a whole AI/ML model 500A in accordance with some embodiments of the present disclosure. For purpose of discussion, FIG. 5 will be described with reference to FIG. 4. In the task response which is described with reference to FIG. 4, the whole AI/ML model 500A (i.e., parameters of the whole AI/ML model 500A) indicated by a model ID may be provided from the second node to the first node. Here, in the example as illustrated in FIG. 5A, the model ID is assumed to be “m1”, and the AI/ML model represented by model ID m1 is intended to be used to perform tasks as requested in the task request with task request ID n1 and task request ID n2.

FIG. 5B illustrates a schematic diagram illustrating a differential AI/ML model 500B in accordance with some embodiments of the present disclosure. For purpose of discussion, FIG. 5 will be described with reference to FIGS. 4 and 5A. In the task response which is described with reference to FIG. 4, the differential AI/ML model 500B may be indicated by a reference model ID and differential value. Here, in the example as illustrated in FIG. 5B, the differential model ID is assumed to be “m2”, and the AI/ML model represented by model ID m2 is intended to be used to perform tasks as requested in the task request with task request ID n3. The reference model ID is indicated to be “m1” in the task response, and as described before, model ID m1 corresponds to a whole AI/ML model as illustrated in FIG. 5A.

As illustrated in FIG. 5B and described above, in the task response, the differential value is also indicated where a differential model ID is provided. In such a case, for model ID m2, a differential indication method is used to indicate that the reference model ID is m1, and to indicate the layer which is different from model m1, and to indicate the specific parameter for the different layer for m2. In this way, the second node may, on receipt of the task response, restore a whole AI/ML model from the indicated differential model, for example, by applying the indicated differential value to the reference model indicated by the reference model ID.

In this way, for an AI/ML model having a common part and a different part from a reference AI/ML model, the second device does not need to transmit the whole AI/ML model to the first device; instead, a model ID of the reference AI/ML model, information of difference data as compared with the reference AI/ML model will suffice for the second device to indicate the AI/ML model to the first device. Therefore, communication overhead can be reduced as compared with a case where a whole AI/ML model, instead of a differential AI/ML model, is transmitted from the second device to the first device.

FIG. 6 illustrates a flowchart of an example method 600 implemented at a first device in accordance with some other embodiments of the present disclosure. The first device may be a base station at the RAN side, for example, the first device may be a network device 120a, 120b or 120c as illustrated in FIG. 1B. In this case, the second device may be a core network (CN), or a 3^{rd} party. Alternatively, the first device may be a terminal device at the RAN side. In this case, the second device may be a network device at the RAN side, or a core network (CN), or a 3^{rd} party. For the purpose of discussion, the method 600 will be described from the perspective of the first device 206 with reference to FIGS. 1B and 2.

At block 610, the first device 206 transmits, to a second device (for example, the second device 208 as illustrated in FIG. 2), a request (for example, request 201 as illustrated in FIG. 2) indicating the second device to provide an artificial intelligence/machine learning (AI/ML) model. Here, the request may comprise at least one of a request identifier (ID), information of a task, a first parameter of input data of the AI/ML model, or a second parameter of output data of the AI/ML model. At block 620, the first device receives a response (for example, response 202 as illustrated in FIG. 2) from the second device.

In some example embodiments, the response may comprise the request ID and one of an acknowledgement (ACK) or a negative acknowledgement (NACK). In this way, the first device 206 can know whether the requested AI/ML model is available or not.

In some example embodiments, the information may comprise a task index indicative of a row of a task table. In addition or as an alternative, the information may comprise a key performance indicator (KPI) index indicative of a KPI requirement for the task, the KPI index indicating a row of a KPI table. In addition or as an alternative, the information may comprise a scenario index indicative of a scenario in which the task is to be performed, the scenario index indicating a row of a scenario table. In this way, the first device 206 can specify some requirements for the desired AI/ML model in the request, in an explicit manner, so as to an AI/ML model which meets the requirements specified by the first device 206 can be obtained from the second device.

In some example embodiments, the task index may indicate a group of functions of an AI/ML model and an achievable performance of the AI/ML model. In this way, the first device 206 can specify some requirements for the desired AI/ML model in the request, in an implicit manner with the task index, so as to an AI/ML model which meets the requirements specified by the first device 206 can be obtained from the second device.

In some example embodiments, the task index may indicate at least one radio resource control (RRC) parameter related to an AI/ML model and a function of the AI/ML model. In this way, the first device 206 can specify some requirements for the desired AI/ML model in the request, so as to an AI/ML model which meets the requirements specified by the first device 206 can be obtained from the second device.

In some example embodiments, the KPI requirement may comprise a performance requirement. In addition or as an alternative, the KPI requirement may comprise an overhead requirement. In addition or as an alternative, the KPI requirement may comprise an inference complexity requirement for an AI/ML model. In addition or as an alternative, the KPI requirement may comprise a training complexity requirement for the AI/ML model. In this way, the first device 206 can specify some KPI requirement for the desired AI/ML model in the request, so as to an AI/ML model which meets the KPI requirement can be obtained from the second device.

In some example embodiments, the scenario may comprise an urban outdoor scenario. In addition or as an alternative, the scenario may comprise an urban indoor scenario. In addition or as an alternative, the scenario may comprise a rural scenario. In addition or as an alternative, the scenario may comprise a highway scenario. In addition or as an alternative, the scenario may comprise a line-of-sight (LOS) scenario. In addition or as an alternative, the scenario may comprise a non-line-of-sight (NLOS) scenario. In addition or as an alternative, the scenario may comprise a windy scenario. In addition or as an alternative, the scenario may comprise a rainy scenario. In this way, the first device 206 can specify a desired scenario (via a scenario index) for the desired AI/ML model in the request, so as to an AI/ML model which is suitable for the scenario can be obtained from the second device.

In some example embodiments, the first parameter may comprise a data type. In addition or as an alternative, the first parameter may comprise a data dimension. In addition or as an alternative, the first parameter may comprise a data granularity. The same is true for the second parameter. In other words, the second parameter may comprise a data type. In addition or as an alternative, the second parameter may comprise a data dimension. In addition or as an alternative, the second parameter may comprise a data granularity. In this way, the first device 206 can specify a desired data type and/or data dimension and/or data granularity for the desired AI/ML model in the request, so as to an AI/ML model which meets the desired data type and/or data dimension and/or data granularity can be obtained from the second device.

In some example embodiments, the request ID may be one of a plurality of request IDs, and the plurality of request IDs may indicate a plurality of requests transmitted from the first device 206 to the second device for requesting a plurality of respective AI/ML models. In this way, the first device 206 can request a plurality of respective AI/ML models via a single request, reducing communication overhead as compared with a case where the request for each of the plurality of AI/ML models are transmitted separately.

In some example embodiments, the response may comprise the ACK, and the response may further indicate a common AI/ML model, where in the response the common AI/MI model is associated with the plurality of request IDs. Alternatively, the response may further indicate the plurality of respective AI/ML models among which an AI/ML model has a first model part and a second model part, the first model part is common to the plurality of respective AI/ML models, and the second model part is different from other AI/ML models among the plurality of respective AI/ML models. In this way, multiple AI/ML models can be feedback from the second device to the first device 206 in a single response, reducing communication overhead as compared with a case where each of the multiple AI/ML models is transmitted separately.

In some example embodiments, the response may indicate an AI/ML model, wherein in the response the AI/ML model is associated with the ACK and at least one request IDs of the plurality of request IDs. In addition or as an alternative, the response may indicate the NACK indicating no AI/ML model is available at the second device for at least one request IDs of the plurality of request IDs. In this way, the response can indicate a case where for multiple request IDs in the request, in the response an AI/ML model is feedback with respect to a first request ID among the multiple request IDs, while a NACK is feedback with respect to a second request ID among the multiple request IDs. In other words, the second device can respond to the request from the first device 206 as per request ID in the request, and provide AI/ML model(s) requested by the first device 206 to the most extent of the capability of the second device.

In some example embodiments, the response may comprise the ACK, and the response may further comprise a model ID of the AI/ML model. In addition or as an alternative, the response may further comprise a model structure of the AI/ML model. In addition or as an alternative, the response may further comprise at least one model parameter of the AI/ML model. In addition or as an alternative, the response may further comprise an indication of whether the AI/ML model is a differential model or a whole model. In this way, provision of the AI/ML model(s) from the second device to the first device 206 can be more flexible and in more granularities.

In some example embodiments, the indication may be indicative of a differential model, and the response may further comprise a model ID of a reference model, information indicative of one or more model parameters of the AI/ML model which are different from the reference AI/ML model, and one or more values of the one or more model parameters of the AI/ML model. In this way, for an AI/ML model having a common part and a different part from a reference AI/ML model, the second device does not need to transmit the whole AI/ML model to the first device 206; instead, a model ID of the reference AI/ML model, information indicative of one or more parameters of the AI/ML model and one or more values of the one or more model parameters will suffice for the second device to indicate the AI/ML model to the first device 206. Therefore, communication overhead can be reduced as compared with a case where a whole AI/ML model, instead of a differential AI/ML model, is transmitted from the second device to the first device 206.

In some example embodiments, the first device 206 may further perform fine-tuning on the AI/ML model to obtain a fine-tuned AI/ML model and provide input data to the fine-tuned AI/ML model to obtain a first output. In doing so, the first device 206 may obtain a second output of a pre-trained AI/ML model to which the input data is provided. Here, the AI/ML model is generated from the pre-trained AI/ML model which is stored at the second device. Then, the first device 206 may monitor inference performance of the fine-tuned AI/ML model based on the first output and the second output. In this way, inference performance (in other words, accuracy) of the local AI/ML model at the first device 206 can be monitored.

In some example embodiments, in order to monitor the inference performance, the first device 206 may determine a difference between the first output and the second output. In this way, inference performance (in other words, accuracy) of the local AI/ML model at the first device 206 can be monitored in the form of the difference between the first output and the second output.

In some example embodiments, the first device 206 may further perform a responsive operation based on determining that the difference is greater than a threshold. Here, the responsive operation may comprise performing further fine-tuning on the fine-tuned AI/ML model. In addition or as an alternative, the responsive operation may comprise switching to another AI/ML model at the first device 206. In addition or as an alternative, the responsive operation may comprise performing the task without using an AI/ML model. In this way, if the difference is greater than a threshold (i.e., the accuracy of the local AI/ML model at the first device 206 deteriorates to be greater than the threshold), the first device 206 can either no longer use the current AI/ML model any more, or perform further fine-tuning on the AI/ML model first to improve the accuracy of the AI/ML model to be accurate enough before continuing to perform the task.

In some example embodiments, in order to obtain the second output, the first device 206 may transmit the input data to the second device, and receives the second output from the second device. In this way, output from the pre-trained big model (which is used as a standard AI/ML model) can be obtained to be compared with a local output at the first device 206 to determine whether inference performance of the local AI/ML model at the first device 206 is good enough.

In some example embodiments, the first device 206 may further transmit local data at the first device 206 to the second device, based on determining that the difference is greater than the threshold. In this way, the first device 206 can rely on the second device to, with help of the data received from the first device 206, provide another AI/ML model which is more suitable for the first device 206 to perform local tasks.

In some example embodiments, the first device 206 may be a terminal device and the second device may be one of an access network device, a core network device, or a third party device. As an alternative, the first device 206 may be an access network device and the second device may be one of a core network device or a third party device. In this way, AI/ML model transfer becomes more flexible and convenient between the first device 206 and the second device.

In this way, according to method 600, a relatively light-weighted customized local AI/ML model can be obtained from a rather big (and “heavy”) global foundation model at the second device, reducing the training complexity at the first device. Meanwhile, the local AI/ML model at the first device is more accurate, thus the first device can perform tasks more accurately.

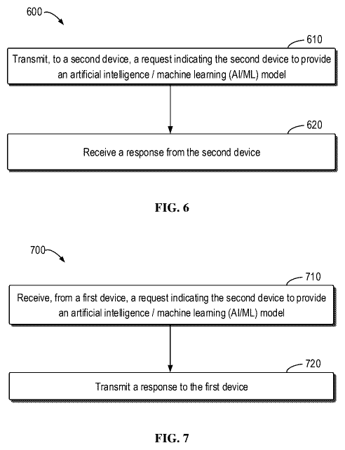

FIG. 7 illustrates another flowchart of an example method 700 implemented at a second device in accordance with some other embodiments of the present disclosure. For the purpose of discussion, the method 700 will be described from the perspective of the second device 208 with reference to FIGS. 1B and 2.

At block 710, the second device 208 receives, from a first device (for example, the first device 206 as illustrated in FIG. 2), a request (for example, request 201 as illustrated in FIG. 2) indicating the second device 208 to provide an artificial intelligence/machine learning (AI/ML) model. Here, the request may comprise at least one of a request identifier (ID), task information of the task, a first parameter of input data of the AI/ML model, or a second parameter of output data of the AI/ML model. At block 720, the second device 208 transmits a response (for example, response 202 as illustrated in FIG. 2) to the first device.

In some example embodiments, the response may comprise the request ID and one of an acknowledgement (ACK) or negative acknowledgement (NACK). In this way, the first device can know whether the requested AI/ML model is available or not.

In some example embodiments, the task information may comprise at least one of a task index indicative of a row of a task table, a key performance indicator (KPI) index indicative of a KPI requirement for the task, the KPI index indicating a row of a KPI table, or a scenario index indicative of a scenario in which the task is to be performed. Here, the scenario index indicates a line of a scenario table. In this way, the first device can specify some requirements for the desired AI/ML model in the request, in an explicit manner, so as to an AI/ML model which meets the requirements specified by the first device can be obtained from the second device 208.

In some example embodiments, the task index may indicate a group of functions of an AI/ML model and an achievable performance of the AI/ML model. In this way, the first device can specify some requirements for the desired AI/ML model in the request, in an implicit manner with the task index, so as to an AI/ML model which meets the requirements specified by the first device can be obtained from the second device 208.

In some example embodiments, the task index may indicate at least one radio resource control (RRC) parameter related to an AI/ML model and a function of the AI/ML model. In this way, the first device can specify some requirements for the desired AI/ML model in the request, so as to an AI/ML model which meets the requirements specified by the first device can be obtained from the second device 208.

In some example embodiments, the KPI requirement may comprise a performance requirement. In addition or as an alternative, the KPI requirement may comprise an overhead requirement. In addition or as an alternative, the KPI requirement may comprise an inference complexity requirement for an AI/ML model. In addition or as an alternative, the KPI requirement may comprise a training complexity requirement for the AI/ML model. In this way, the first device can specify some KPI requirement for the desired AI/ML model in the request, so as to an AI/ML model which meets the KPI requirement can be obtained from the second device 208.

In some example embodiments, the scenario may comprise an urban outdoor scenario. In addition or as an alternative, the scenario may comprise an urban indoor scenario. In addition or as an alternative, the scenario may comprise a rural scenario. In addition or as an alternative, the scenario may comprise a highway scenario. In addition or as an alternative, the scenario may comprise a line-of-sight (LOS) scenario. In addition or as an alternative, the scenario may comprise a non-line-of-sight (NLOS) scenario. In addition or as an alternative, the scenario may comprise a windy scenario. In addition or as an alternative, the scenario may comprise a rainy scenario. In this way, the first device can specify a desired scenario (via a scenario index) for the desired AI/ML model in the request, so as to an AI/ML model which is suitable for the scenario can be obtained from the second device 208.

In some example embodiments, the first parameter may comprise a data type. In addition or as an alternative, the first parameter may comprise a data dimension. In addition or as an alternative, the first parameter may comprise a data granularity. The same is true for the second parameter. In other words, the second parameter may comprise a data type. In addition or as an alternative, the second parameter may comprise a data dimension. In addition or as an alternative, the second parameter may comprise a data granularity. In this way, the first device can specify a desired data type and/or data dimension and/or data granularity for the desired AI/ML model in the request, so as to an AI/ML model which meets the desired data type and/or data dimension and/or data granularity can be obtained from the second device 208.

In some example embodiments, the request ID may be one of a plurality of request IDs, and the plurality of request IDs may indicate a plurality of requests transmitted from the first device to the second device for requesting a plurality of respective AI/ML models. In this way, the first device can request a plurality of respective AI/ML models via a single request, reducing communication overhead as compared with a case where the request for each of the plurality of AI/ML models are transmitted separately.

In some example embodiments, the response may comprise the ACK, and the response may further indicate a common AI/ML model, where in the response the common AI/MI model is associated with the plurality of request IDs. Alternatively, the response may further indicate the plurality of respective AI/ML models among which an AI/ML model has a first model part and a second model part, the first model part is common to the plurality of respective AI/ML models, and the second model part is different from other AI/ML models among the plurality of respective AI/ML models. In this way, multiple AI/ML models can be feedback from the second device 208 to the first device in a single response, reducing communication overhead as compared with a case where each of the multiple AI/ML models is transmitted separately.

In some example embodiments, the response may indicate an AI/ML model, wherein in the response the AI/ML model is associated with the ACK and at least one request IDs of the plurality of request IDs. In addition or as an alternative, the response may indicate the NACK indicating no AI/ML model is available at the second device for at least one request IDs of the plurality of request IDs. In this way, the response can indicate a case where for multiple request IDs in the request, in the response an AI/ML model is feedback with respect to a first request ID among the multiple request IDs, while a NACK is feedback with respect to a second request ID among the multiple request IDs. In other words, the second device 208 can respond to the request from the first device as per request ID in the request, and provide AI/ML model(s) requested by the first device to the most extent of the capability of the second device 208.

In some example embodiments, the response may comprise the ACK, and the response may further comprise a model ID of the AI/ML model. In addition or as an alternative, the response may further comprise a model structure of the AI/ML model. In addition or as an alternative, the response may further comprise at least one model parameter of the AI/ML model. In addition or as an alternative, the response may further comprise an indication of whether the AI/ML model is a differential model or a whole model. In this way, provision of the AI/ML model(s) from the second device 208 to the first device can be more flexible and in more granularities.

In some example embodiments, the indication may be indicative of a differential model, and the response may further comprise a model ID of a reference model, information indicative of one or more model parameters of the AI/ML model which are different from the reference AI/ML model, and one or more values of the one or more model parameters of the AI/ML model. In this way, for an AI/ML model having a common part and a different part from a reference AI/ML model, the second device 208 does not need to transmit the whole AI/ML model to the first device; instead, a model ID of the reference AI/ML model, information indicative of one or more parameters of the AI/ML model and one or more values of the one or more model parameters will suffice for the second device 208 to indicate the AI/ML model to the first device. Therefore, communication overhead can be reduced as compared with a case where a whole AI/ML model, instead of a differential AI/ML model, is transmitted from the second device 208 to the first device.

In some example embodiments, the second device 208 may further receive, from the first device, an input data (for example, in a format of embedding data), and provide the input data to a local AI/ML model to obtain a second output. Here, the AI/ML model is generated based on the local AI/ML model. Then, the second device 208 may transmit the second output to the first device. In this way, with the second output from the second device 208, the inference performance (in other words, accuracy) of the local AI/ML model at the first device can be monitored.

In some example embodiments, the first device may be a terminal device and the second device 208 may be one of an access network device, a core network device, or a third party device. As an alternative, the first device may be an access network device and the second device 208 may be one of a core network device or a third party device. In this way, AI/ML model transfer becomes more flexible and convenient between the first and second devices.

In this way, according to method 700, rather than a rather big (and “heavy”) global foundation model, a relatively light-weighted customized AI/ML model can be provided to the first device, reducing the training complexity at the first device. Meanwhile, the AI/ML model at the first device is more accurate, thus the first device can perform tasks more accurately. Further, the second device may use data received from the first device to train the global foundation model to be more accurate for the plurality of tasks.

FIG. 8 illustrates a simplified block diagram of an apparatus 800 according to some example embodiments of the present disclosure. The apparatus 800 may be implemented as a device or a chip in the device, and the scope of the present application is not limited in this respect. The first device may be a base station at the RAN side, for example, the first device may be a network device 120a, 120b or 120c as illustrated in FIG. 1B. In this case, the second device may be a core network (CN), or a 3^{rd} party. Alternatively, the first device may be a terminal device at the RAN side. In this case, the second device may be a network device at the RAN side, or a core network (CN), or a 3^{rd} party. The apparatus 800 may include multiple modules for performing corresponding processes in the method 600 as discussed in FIG. 6. The apparatus 800 may be implemented as the first device 206 as shown in FIG. 2 or a part of the first device. FIG. 8 will be described below with reference to FIGS. 1B and 2.

As illustrated in FIG. 8, the apparatus 800 comprises a transmitting module 810 and a receiving module 820. The apparatus 800 may also comprise a processing module 830. The transmitting module 810 is used to transmit data, the receiving module 820 is used to receive data, and the processing module 830 may be used to process data. For example, the transmitting module 810 is configured to transmit, at a first device (for example, the first device 206 as illustrated in FIG. 2) and to a second device (for example, the second device 208 as illustrated in FIG. 2), a request (for example, request 201 as illustrated in FIG. 2) indicating the second device to provide an artificial intelligence/machine learning (AI/ML) model. Here, the request may comprise at least one of a request identifier (ID), information of a task, a first parameter of input data of the AI/ML model, or a second parameter of output data of the AI/ML model. The receiving module 820 is configured to receive a response (for example, response 202 as illustrated in FIG. 2) from the second device. The processing module 830 may be configured to perform fine-tuning on the AI/ML model to obtain a fine-tuned AI/ML model.

In some example embodiments, the response may comprise the request ID and one of an acknowledgement (ACK) or a negative acknowledgement (NACK). In this way, the first device can know whether the requested AI/ML model is available or not.

In some example embodiments, the information may comprise a task index indicative of a row of a task table. In addition or as an alternative, the information may comprise a key performance indicator (KPI) index indicative of a KPI requirement for the task, the KPI index indicating a row of a KPI table. In addition or as an alternative, the information may comprise a scenario index indicative of a scenario in which the task is to be performed, the scenario index indicating a row of a scenario table. In this way, the first device can specify some requirements for the desired AI/ML model in the request, in an explicit manner, so as to an AI/ML model which meets the requirements specified by the first device can be obtained from the second device.

In some example embodiments, the task index may indicate a group of functions of an AI/ML model and an achievable performance of the AI/ML model. In this way, the first device can specify some requirements for the desired AI/ML model in the request, in an implicit manner with the task index, so as to an AI/ML model which meets the requirements specified by the first device can be obtained from the second device.

In some example embodiments, the task index may indicate at least one radio resource control (RRC) parameter related to an AI/ML model and a function of the AI/ML model. In this way, the first device can specify some requirements for the desired AI/ML model in the request, so as to an AI/ML model which meets the requirements specified by the first device can be obtained from the second device.

In some example embodiments, the KPI requirement may comprise a performance requirement. In addition or as an alternative, the KPI requirement may comprise an overhead requirement. In addition or as an alternative, the KPI requirement may comprise an inference complexity requirement for an AI/ML model. In addition or as an alternative, the KPI requirement may comprise a training complexity requirement for the AI/ML model. In this way, the first device can specify some KPI requirement for the desired AI/ML model in the request, so as to an AI/ML model which meets the KPI requirement can be obtained from the second device.

In some example embodiments, the scenario may comprise an urban outdoor scenario. In addition or as an alternative, the scenario may comprise an urban indoor scenario. In addition or as an alternative, the scenario may comprise a rural scenario. In addition or as an alternative, the scenario may comprise a highway scenario. In addition or as an alternative, the scenario may comprise a line-of-sight (LOS) scenario. In addition or as an alternative, the scenario may comprise a non-line-of-sight (NLOS) scenario. In addition or as an alternative, the scenario may comprise a windy scenario. In addition or as an alternative, the scenario may comprise a rainy scenario. In this way, the first device can specify a desired scenario (via a scenario index) for the desired AI/ML model in the request, so as to an AI/ML model which is suitable for the scenario can be obtained from the second device.

In some example embodiments, the first parameter may comprise a data type. In addition or as an alternative, the first parameter may comprise a data dimension. In addition or as an alternative, the first parameter may comprise a data granularity. The same is true for the second parameter. In other words, the second parameter may comprise a data type. In addition or as an alternative, the second parameter may comprise a data dimension. In addition or as an alternative, the second parameter may comprise a data granularity. In this way, the first device can specify a desired data type and/or data dimension and/or data granularity for the desired AI/ML model in the request, so as to an AI/ML model which meets the desired data type and/or data dimension and/or data granularity can be obtained from the second device.

In some example embodiments, the request ID may be one of a plurality of request IDs, and the plurality of request IDs may indicate a plurality of requests transmitted from the first device to the second device for requesting a plurality of respective AI/ML models. In this way, the first device can request a plurality of respective AI/ML models via a single request, reducing communication overhead as compared with a case where the request for each of the plurality of AI/ML models are transmitted separately.

In some example embodiments, the response may comprise the ACK, and the response may further indicate a common AI/ML model, where in the response the common AI/MI model is associated with the plurality of request IDs. Alternatively, the response may further indicate the plurality of respective AI/ML models among which an AI/ML model has a first model part and a second model part, the first model part is common to the plurality of respective AI/ML models, and the second model part is different from other AI/ML models among the plurality of respective AI/ML models. In this way, multiple AI/ML models can be feedback from the second device to the first device in a single response, reducing communication overhead as compared with a case where each of the multiple AI/ML models is transmitted separately.

In some example embodiments, the response may indicate an AI/ML model, wherein in the response the AI/ML model is associated with the ACK and at least one request IDs of the plurality of request IDs. In addition or as an alternative, the response may indicate the NACK indicating no AI/ML model is available at the second device for at least one request IDs of the plurality of request IDs. In this way, the response can indicate a case where for multiple request IDs in the request, in the response an AI/ML model is feedback with respect to a first request ID among the multiple request IDs, while a NACK is feedback with respect to a second request ID among the multiple request IDs. In other words, the second device can respond to the request from the first device as per request ID in the request, and provide AI/ML model(s) requested by the first device to the most extent of the capability of the second device.

In some example embodiments, the response may comprise the ACK, and the response may further comprise a model ID of the AI/ML model. In addition or as an alternative, the response may further comprise a model structure of the AI/ML model. In addition or as an alternative, the response may further comprise at least one model parameter of the AI/ML model. In addition or as an alternative, the response may further comprise an indication of whether the AI/ML model is a differential model or a whole model. In this way, provision of the AI/ML model(s) from the second device to the first device can be more flexible and in more granularities.

In some example embodiments, the indication may be indicative of a differential model, and the response may further comprise a model ID of a reference model, information indicative of one or more model parameters of the AI/ML model which are different from the reference AI/ML model, and one or more values of the one or more model parameters of the AI/ML model. In this way, for an AI/ML model having a common part and a different part from a reference AI/ML model, the second device does not need to transmit the whole AI/ML model to the first device; instead, a model ID of the reference AI/ML model, information indicative of one or more parameters of the AI/ML model and one or more values of the one or more model parameters will suffice for the second device to indicate the AI/ML model to the first device. Therefore, communication overhead can be reduced as compared with a case where the AI/ML model itself is transmitted from the second device to the first device.

In some example embodiments, the apparatus 800 may further comprise a performing module configured to perform fine-tuning on the AI/ML model to obtain a fine-tuned AI/ML model and a providing module configured to provide input data to the fine-tuned AI/ML model to obtain a first output. The apparatus 800 may further comprise an obtaining module configured to obtain a second output of a pre-trained AI/ML model to which the input data is provided. Here, the AI/ML model is generated from the pre-trained AI/ML model which is stored at the second device. The apparatus 800 may further comprise a monitoring module configured to monitor inference performance of the fine-tuned AI/ML model based on the first output and the second output. In this way, inference performance (in other words, accuracy) of the local AI/ML model at the first device can be monitored.

In some example embodiments, the monitoring module may comprise a determining module configured to determine a difference between the first output and the second output. In this way, inference performance (in other words, accuracy) of the local AI/ML model at the first device can be monitored in the form of the difference between the first output and the second output.

In some example embodiments, the apparatus 800 may further comprise performing means configured to perform a responsive operation based on determining that the difference is greater than a threshold. Here, the responsive operation may comprise at least one of performing further fine-tuning on the fine-tuned AI/ML model, switching to another AI/ML model at the first device, or performing the task without using an AI/ML model. In this way, if the difference is greater than a threshold (i.e., the accuracy of the local AI/ML model at the first device deteriorates to be greater than the threshold), the first device can either no longer use the current AI/ML model any more, or perform further fine-tuning on the AI/ML model first to improve the accuracy of the AI/ML model to be accurate enough before continuing to perform the task.

In some example embodiments, the obtaining module may comprise a transmitting module configured to transmit the input data to the second device, and a receiving module configured to receive the second output from the second device. In this way, output from the pre-trained big model (which is used as a standard AI/ML model) can be obtained to be compared with a local output at the first device to determine whether inference performance of the local AI/ML model at the first device is good enough.

In some example embodiments, the apparatus 800 may further comprise a transmitting module configured to transmit local data at the first device to the second device, based on determining that the difference is greater than the threshold. In this way, the first device can rely on the second device to, with help of the data received from the first device, provide another AI/ML model which is more suitable for the first device to perform local tasks.

In some example embodiments, the first device may be a terminal device and the second device may be one of an access network device, a core network device, or a third party device. As an alternative, the first device may be an access network device and the second device may be one of a core network device or a third party device. In this way, AI/ML model transfer becomes more flexible and convenient between the first and second devices.

In this way, with the apparatus 800, a relatively light-weighted customized local AI/ML model can be obtained from a rather big (and “heavy”) global foundation model at the second device, reducing the training complexity at the first device. Meanwhile, the local AI/ML model at the first device is more accurate, thus the first device can perform tasks more accurately.

FIG. 9 illustrates a simplified block diagram of an apparatus 900 according to some example embodiments of the present disclosure. The apparatus 900 may be implemented as a device or a chip in the device, and the scope of the present application is not limited in this respect. The apparatus 900 may include multiple modules for performing corresponding processes in the method 700 as discussed in FIG. 7. The apparatus 900 may be implemented as the second device 208 as shown in FIG. 1B or 2 or a part of the second device 208. FIG. 9 will be described below with reference to FIGS. 1B and 2.

As illustrated in FIG. 9, the apparatus 900 comprises a receiving module 910 and a transmitting module 930. The apparatus 900 may also comprise a processing module 930. The receiving module 910 is used to receive data, the transmitting module 920 is used to transmit data, and the processing module 930 may be configured to process data. For example, the receiving module 910 is configured to receive, at a second device (for example, the second device 208 as illustrated in FIG. 2) and from a first device (for example, the first device 206 as illustrated in FIG. 2), a request (for example, the request 201 as illustrated in FIG. 2) indicating the second device to provide an artificial intelligence/machine learning (AI/ML) model. Here, the request may comprise at least one of a request identifier (ID), task information of the task, a first parameter of input data of the AI/ML model, or a second parameter of output data of the AI/ML model. The transmitting module 920 is configured to transmit a response (for example, response 202 as illustrated in FIG. 2) to the first device. The processing module 930 may be configured to receive, from the first device, an input data and transmit a second output with respect to the input data to the first device.

In some example embodiments, the response may comprise the request ID and one of an acknowledgement (ACK) or negative acknowledgement (NACK). In this way, the first device can know whether the requested AI/ML model is available or not.

In some example embodiments, the task information may comprise at least one of a task index indicative of a row of a task table, a key performance indicator (KPI) index indicative of a KPI requirement for the task, the KPI index indicating a row of a KPI table, or a scenario index indicative of a scenario in which the task is to be performed. Here, the scenario index indicates a line of a scenario table. In this way, the first device can specify some requirements for the desired AI/ML model in the request, in an explicit manner, so as to an AI/ML model which meets the requirements specified by the first device can be obtained from the second device.

In some example embodiments, the task index may indicate a group of functions of an AI/ML model and an achievable performance of the AI/ML model. In this way, the first device can specify some requirements for the desired AI/ML model in the request, in an implicit manner with the task index, so as to an AI/ML model which meets the requirements specified by the first device can be obtained from the second device.

In some example embodiments, the task index may indicate at least one radio resource control (RRC) parameter related to an AI/ML model and a function of the AI/ML model. In this way, the first device can specify some requirements for the desired AI/ML model in the request, so as to an AI/ML model which meets the requirements specified by the first device can be obtained from the second device.

In some example embodiments, the KPI requirement may comprise a performance requirement. In addition or as an alternative, the KPI requirement may comprise an overhead requirement. In addition or as an alternative, the KPI requirement may comprise an inference complexity requirement for an AI/ML model. In addition or as an alternative, the KPI requirement may comprise a training complexity requirement for the AI/ML model. In this way, the first device can specify some KPI requirement for the desired AI/ML model in the request, so as to an AI/ML model which meets the KPI requirement can be obtained from the second device.

In some example embodiments, the scenario may comprise an urban outdoor scenario. In addition or as an alternative, the scenario may comprise an urban indoor scenario. In addition or as an alternative, the scenario may comprise a rural scenario. In addition or as an alternative, the scenario may comprise a highway scenario. In addition or as an alternative, the scenario may comprise a line-of-sight (LOS) scenario. In addition or as an alternative, the scenario may comprise a non-line-of-sight (NLOS) scenario. In addition or as an alternative, the scenario may comprise a windy scenario. In addition or as an alternative, the scenario may comprise a rainy scenario. In this way, the first device can specify a desired scenario (via a scenario index) for the desired AI/ML model in the request, so as to an AI/ML model which is suitable for the scenario can be obtained from the second device.

In some example embodiments, the first parameter may comprise a data type. In addition or as an alternative, the first parameter may comprise a data dimension. In addition or as an alternative, the first parameter may comprise a data granularity. The same is true for the second parameter. In other words, the second parameter may comprise a data type. In addition or as an alternative, the second parameter may comprise a data dimension. In addition or as an alternative, the second parameter may comprise a data granularity. In this way, the first device can specify a desired data type and/or data dimension and/or data granularity for the desired AI/ML model in the request, so as to an AI/ML model which meets the desired data type and/or data dimension and/or data granularity can be obtained from the second device.

In some example embodiments, the request ID may be one of a plurality of request IDs, and the plurality of request IDs may indicate a plurality of requests transmitted from the first device to the second device for requesting a plurality of respective AI/ML models. In this way, the first device can request a plurality of respective AI/ML models via a single request, reducing communication overhead as compared with a case where the request for each of the plurality of AI/ML models are transmitted separately.

In some example embodiments, the response may comprise the ACK, and the response may further indicate a common AI/ML model, where in the response the common AI/MI model is associated with the plurality of request IDs. Alternatively, the response may further indicate the plurality of respective AI/ML models among which an AI/ML model has a first model part and a second model part, the first model part is common to the plurality of respective AI/ML models, and the second model part is different from other AI/ML models among the plurality of respective AI/ML models. In this way, multiple AI/ML models can be feedback from the second device to the first device in a single response, reducing communication overhead as compared with a case where each of the multiple AI/ML models is transmitted separately.

In some example embodiments, the response may indicate an AI/ML model, wherein in the response the AI/ML model is associated with the ACK and at least one request IDs of the plurality of request IDs. In addition or as an alternative, the response may indicate the NACK indicating no AI/ML model is available at the second device for at least one request IDs of the plurality of request IDs. In this way, the response can indicate a case where for multiple request IDs in the request, in the response an AI/ML model is feedback with respect to a first request ID among the multiple request IDs, while a NACK is feedback with respect to a second request ID among the multiple request IDs. In other words, the second device can respond to the request from the first device as per request ID in the request, and provide AI/ML model(s) requested by the first device to the most extent of the capability of the second device.

In some example embodiments, the response may comprise the ACK, and the response may further comprise a model ID of the AI/ML model. In addition or as an alternative, the response may further comprise a model structure of the AI/ML model. In addition or as an alternative, the response may further comprise at least one model parameter of the AI/ML model. In addition or as an alternative, the response may further comprise an indication of whether the AI/ML model is a differential model or a whole model. In this way, provision of the AI/ML model(s) from the second device to the first device can be more flexible and in more granularities.

In some example embodiments, the indication may be indicative of a differential model, and the response may further comprise a model ID of a reference model, information indicative of one or more model parameters of the AI/ML model which are different from the reference AI/ML model, and one or more values of the one or more model parameters of the AI/ML model. In this way, for an AI/ML model having a common part and a different part from a reference AI/ML model, the second device does not need to transmit the whole AI/ML model to the first device; instead, a model ID of the reference AI/ML model, information indicative of one or more parameters of the AI/ML model and one or more values of the one or more model parameters will suffice for the second device to indicate the AI/ML model to the first device. Therefore, communication overhead can be reduced as compared with a case where the AI/ML model itself is transmitted from the second device to the first device.

In some example embodiments, the apparatus 900 may further comprise a receiving module configured to receive, from the first device, an input data (for example, in a format of embedding data), and a providing means configured to provide the input data to a local AI/ML model to obtain a second output. Here, the AI/ML model is generated based on the local AI/ML model. The apparatus 900 may further comprise a transmitting module configured to transmit the second output to the first device. In this way, with the second output from the second device, the inference performance (in other words, accuracy) of the local AI/ML model at the first device can be monitored.

In some example embodiments, the first device may be a terminal device and the second device may be one of an access network device, a core network device, or a third party device. As an alternative, the first device may be an access network device and the second device may be one of a core network device or a third party device. In this way, AI/ML model transfer becomes more flexible and convenient between the first and second devices.

In this way, with the apparatus 900, rather than a rather big (and “heavy”) global foundation model, a relatively light-weighted customized AI/ML model can be provided to the first device, reducing the training complexity at the first device. Meanwhile, the AI/ML model at the first device is more accurate, thus the first device can perform tasks more accurately. Further, the second device may use data received from the first device to train the global foundation model to be more accurate for the plurality of tasks.

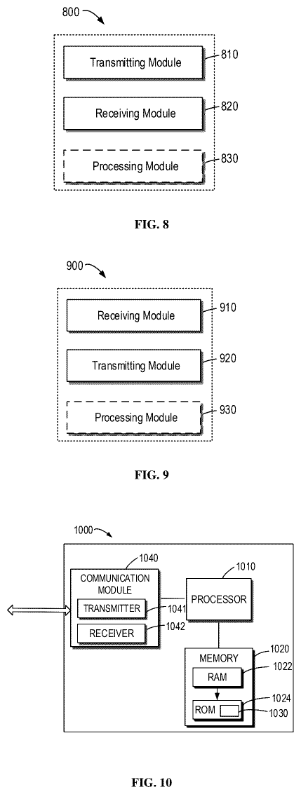

FIG. 10 illustrates a simplified block diagram of a device 1000 that is suitable for implementing some example embodiments of the present disclosure. The device 1000 may be provided to implement a communication device, for example, the first device 206 or the second device 208 as shown in FIG. 2. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 may include a transmitter 1041 for transmitting data and a receiver 1042 for receiving data. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program 1030 so that the device 1000 may perform any process of the disclosure as discussed with reference to FIGS. 2, 4 and 6-7. The embodiments of the present disclosure may also be implemented by hardware or by a combination of software and hardware.

In some example embodiments, the program 1030 may be tangibly contained in a computer-readable medium which may be included in the device 1000 (such as in the memory 1020) or other storage devices that are accessible by the device 1000. The device 1000 may load the program 1030 from the computer-readable medium to the RAM 1022 for execution. The computer-readable medium may include any types of tangible non-volatile storage, such as ROM, EPROM, a flash memory, a hard disk, CD, DVD, and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 600 or 700 as described above with reference to FIGS. 2, 4 and 6-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Through this document, the terms defined below may be referenced.
LTE Long Term Evolution
NR New Radio
BWP Bandwidth part
BS Base Station
CA Carrier Aggregation
CC Component Carrier
CG Cell Group
CSI Channel state information
CSI-RS Channel state information Reference Signal
DC Dual Connectivity
DCI Downlink control information
DL Downlink
DL-SCH Downlink shared channel
EN-DC E-UTRA NR dual connectivity with MCG using E-UTRA and SCG using NR
gNB Next generation (or 5G) base station
HARQ-ACK Hybrid automatic repeat request acknowledgement
MCG Master cell group
MCS Modulation and coding scheme
MAC-CE Medium Access Control-Control Element
PBCH Physical broadcast channel
PCell Primary cell
PDCCH Physical downlink control channel
PDSCH Physical downlink shared channel
PRACH Physical Random Access Channel
PRG Physical resource block group
PSCell Primary SCG Cell
PSS Primary synchronization signal
PUCCH Physical uplink control channel
PUSCH Physical uplink shared channel
RACH Random access channel
RAPID Random access preamble identity
RB Resource block
RE Resource element
RRM Radio resource management
RMSI Remaining system information
RS Reference signal
RSRP Reference signal received power
RRC Radio Resource Control
SCG Secondary cell group
SFN System frame number
SL Sidelink
SCell Secondary Cell
SPS Semi-persistent scheduling
SR Scheduling request
SRI SRS resource indicator
SRS Sounding reference signal
SSS Secondary synchronization signal
SSB Synchronization Signal Block
SUL Supplement Uplink
TA Timing advance
TAG Timing advance group
TUE target UE
UCI Uplink control information
UE User Equipment
UL Uplink
UL-SCH Uplink shared channel

What is claimed is:

1. A method comprising:
transmitting, at a first device and to a second device, a request indicating the second device to provide an artificial intelligence/machine learning (AI/ML) model, wherein the request comprises at least one of the following:
a request identifier (ID),
task information of a task,
a first parameter of input data of the AI/ML model, or
a second parameter of output data of the AI/ML model; and
receiving a response from the second device.

2. The method of claim 1, wherein the response comprises the request ID and one of an acknowledgement (ACK) or a negative acknowledgement (NACK).

3. The method of claim 1, wherein the information comprises at least one of the following:
a task index indicative of a row of a task table,
a key performance indicator (KPI) index indicative of a KPI requirement for the task, the KPI index indicating a row of a KPI table, or
a scenario index indicative of a scenario in which the task is to be performed, the scenario index indicating a row of a scenario table.

4. The method of claim 3, wherein the KPI requirement comprises at least one of the following:
a performance requirement,
an overhead requirement,
an inference complexity requirement for the AI/ML model, or
a training complexity requirement for the AI/ML model.

5. The method of claim 3, wherein the scenario comprises at least one of the following:
an urban outdoor scenario,
an urban indoor scenario,
a rural scenario,
a highway scenario,
a line-of-sight (LOS) scenario,
a non-line-of-sight (NLOS) scenario,
a windy scenario, or
a rainy scenario.

6. A method comprising:
receiving, at a second device and from a first device, a request indicating the second device to provide an artificial intelligence/machine learning (AI/ML) model, wherein the request comprises at least one of the following:
a request identifier (ID),
task information of the task,
a first parameter of input data of the AI/ML model, or
a second parameter of output data of the AI/ML model; and
transmitting a response to the first device.

7. The method of claim 6, wherein the response comprises the request ID and one of an acknowledgement (ACK) or negative acknowledgement (NACK).

8. The method of claim 6, wherein the task information comprises at least one of the following:
a task index indicative of a row of a task table,
a key performance indicator (KPI) index indicative of a KPI requirement for the task, the KPI index indicating a row of a KPI table, or
a scenario index indicative of a scenario in which the task is to be performed, the scenario index indicating a line of a scenario table.

9. The method of claim 8, wherein the KPI requirement comprises at least one of the following:
a performance requirement,
an overhead requirement,
an inference complexity requirement for the AI/ML model, or
a training complexity requirement for the AI/ML model.

10. The method of claim 8, wherein the scenario comprises at least one of the following:
an urban outdoor scenario,
an urban indoor scenario,
a rural scenario,
a highway scenario,
a line-of-sight (LOS) scenario,
a non-line-of-sight (NLOS) scenario,
a windy scenario, or
a rainy scenario.

11. An apparatus comprising:
at least one processor coupled with a memory storing instructions, wherein when the instructions executed by the at least one processor, the apparatus is caused to:
transmit, to a second device, a request indicating the second device to provide an artificial intelligence/machine learning (AI/ML) model, wherein the request comprises at least one of the following:
a request identifier (ID),
task information of a task,
a first parameter of input data of the AI/ML model, or
a second parameter of output data of the AI/ML model; and
receive a response from the second device.

12. The apparatus of claim 11, wherein the response comprises the request ID and one of an acknowledgement (ACK) or a negative acknowledgement (NACK).

13. The apparatus of claim 11, wherein the information comprises at least one of the following:
a task index indicative of a row of a task table,
a key performance indicator (KPI) index indicative of a KPI requirement for the task, the KPI index indicating a row of a KPI table, or
a scenario index indicative of a scenario in which the task is to be performed, the scenario index indicating a row of a scenario table.

14. The apparatus of claim 13, wherein the KPI requirement comprises at least one of the following:
a performance requirement,
an overhead requirement,
an inference complexity requirement for the AI/ML model, or
a training complexity requirement for the AI/ML model.

15. The apparatus of claim 13, wherein the scenario comprises at least one of the following:
an urban outdoor scenario,
an urban indoor scenario,
a rural scenario,
a highway scenario,
a line-of-sight (LOS) scenario,
a non-line-of-sight (NLOS) scenario,
a windy scenario, or
a rainy scenario.

16. An apparatus comprising:
at least one processor coupled with a memory storing instructions, wherein when the instructions executed by the at least one processor, the apparatus is caused to:
receive, at a second device and from a first device, a request indicating the second device to provide an artificial intelligence/machine learning (AI/ML) model, wherein the request comprises at least one of the following:
a request identifier (ID),
task information of the task,
a first parameter of input data of the AI/ML model, or
a second parameter of output data of the AI/ML model; and
transmit a response to the first device.

17. The apparatus of claim 16, wherein the response comprises the request ID and one of an acknowledgement (ACK) or negative acknowledgement (NACK).

18. The apparatus of claim 16, wherein the task information comprises at least one of the following:
a task index indicative of a row of a task table,
a key performance indicator (KPI) index indicative of a KPI requirement for the task, the KPI index indicating a row of a KPI table, or
a scenario index indicative of a scenario in which the task is to be performed, the scenario index indicating a line of a scenario table.

19. The apparatus of claim 18, wherein the KPI requirement comprises at least one of the following:
a performance requirement,
an overhead requirement,
an inference complexity requirement for the AI/ML model, or
a training complexity requirement for the AI/ML model.

20. The apparatus of claim 18, wherein the scenario comprises at least one of the following:
an urban outdoor scenario,
an urban indoor scenario,
a rural scenario,
a highway scenario,
a line-of-sight (LOS) scenario,
a non-line-of-sight (NLOS) scenario,
a windy scenario, or
a rainy scenario.
